(19) United States
(12) Patent Application Publication
(10) Pub. No.: US 2011/0052755 A1
(43) Pub. Date: Mar. 3, 2011

(54) SWEETENER COMPOSITIONS

(76) Inventors: Francesca Fiorenza, Siracusa (IT); Leanne Fisher, Reading (GB); Carole Anne Bingley, Reading (GB)

(21) Appl. No.: 12/671,047

(22) PCT Filed: Jul. 30, 2008
(86) PCT No.: PCT/GB08/02601

§ 371 Date: Nov. 3, 2010

(30) Foreign Application Priority Data
Aug. 1, 2007 (GB) 0715226.7

(51) Int. Cl. A23L 1/236; A23L 1/29; A23L 2/60

(52) U.S. Cl. 426/3; 426/548

(57) ABSTRACT

Provided is a sweetener composition comprising: an extract from the leaves of the Stevia Rebaudiana plant and/or an extract from the leaves of the Rubus suavissimus plant; and an extract from the fruit of the Cucurbitaceae family; wherein the ratio of a:b is in the range 50:50 to 95:05 and a method of making such composition and its use in a beverage or foodstuff. Also provided is a method of improving the taste of a beverage or foodstuff comprising incorporating the sweetener composition into the beverage or foodstuff.

The invention relates to sweetener compositions and to methods of preparing sweetener compositions, in addition the invention relates to the use of such compositions for improving the taste of confectionery products.

Non-caloric high-potency sweeteners have become popular in consumer diets as an aid to weight loss. However, natural caloric sweetener compositions, such as sucrose, fructose, and glucose are regarded as providing the most desirable taste to consumers.

Until now, non-caloric sweeteners have been unable to offer a comparable taste sensation as their sweetness/flavour profiles and response times have been unable to mimic that of caloric sweeteners. For instance, the sweet tastes of some natural and synthetic high-potency sweeteners are typically slower in onset and longer in duration than the sweet taste produced by sugar and thus change the taste balance of a food composition. As a result of these differences, the use of natural and synthetic high-potency sweeteners to replace a bulk sweetener, such as sugar, in a food or beverage causes an unbalanced sweetness profile and/or flavour profile. Additionally, some non-caloric sweeteners generally exhibit off tastes including bitter, metallic, cooling, astringent and liquorice-like tastes. As such, it is well known that changing the sweetener in a composition requires re-balancing of the flavour and other taste components.

For this reason it would be desirable to selectively modify the taste characteristics of non-caloric sweeteners to offer an improved sweetness profile.

In addition, there is a growing public desire for products which are “natural”, such products are perceived as better for the health and the environment. Accordingly, it would be desirable to offer a naturally derived non-caloric sweetener composition with an improved sweetness profile.

Various blends of sweeteners are known, for instance US 2007/0081206 teaches the combination of sugar alcohols and D-tagatose in a variety of zero- or low calorie beverages. Other combinations of sweeteners may also be used including Stevias and Lo Han Guo extracts.

Blends of sweeteners including Lo Han Guo have been proposed in the prior art. US 2003/0170365 A1 discloses a blend of Lo Han Guo fruit concentrate powder, isomalt and fructo-oligosaccharide so as to eradicate undesired lingering aftertaste.

US 2007/0003679 relates to a blend of a Stevia-derived sweet substance and cyclodextrin, the cyclodextrin being present to the bitter taste inherent in a Stevia-derived sweet substance.

The invention seeks to fulfil the need for an improved natural sweetener through the provision of a synergistic combination of two natural sweeteners. Accordingly, in a first aspect of the invention there is provided a sweetener composition comprising:
a. an extract from the leaves of the Stevia Rebaudiana plant and/or an extract from the leaves of the Rubus suavissimus plant; and
b. an extract from the fruit of the Cucurbitaceae family;
   wherein the ratio of a:b is in the range 50:50 to 95:05.

In a second aspect of the invention there is provided a method of making a sweetener composition comprising combining an extract from the leaves of the Stevia Rebaudiana plant and/or an extract from the leaves of the Rubus suavissimus plant, with an extract from the fruit of the Cucurbitaceae family; in a ratio in the range 50:50 to 95:05.

A third aspect of the invention provides a method of improving the taste of a beverage or foodstuff comprising incorporating the sweetener composition of the first aspect of the invention into the beverage or foodstuff.

The use of a sweetener composition in a beverage or foodstuff is also provided in a fourth aspect of the invention.

The Steviosides obtained from the Stevia (Stevia Rebaudiana) or the Rubus suavissimus plants are from about 50 to 450 times sweeter than sugar. Since these intensely sweet Stevia-derived sweet substances can be used in amounts from about 1/50th to 1/450th that of sugar an interest has arisen in Steviosides as sugar-substitute sweeteners.

Steviosides, however, have a characteristically bitter taste that is not present in sugar, in addition, liquorice flavours are often observed in Stevia extracts. The sweetness intensity and level of the “off-flavours” (i.e. the bitterness and liquorice flavours) depends upon the purity of the plant extract and the level of rebaudioside A present.

Lo Han Guo (hereinafter called “LHG”), sometimes spelled Lo Han Kuo, is the common name for the Chinese fruit Momordica grosvenorii (Swingle), also called Siraitia grosvenorii, belonging to the Cucurbitaceae family. Siraitia grosvenorii is an herbaceous perennial vine native to southern China and best known for its fruit, the LHG. Botanical synonyms include Momordica grosvenorii and Thladiantha grosvenorii.

The fruit is well known for its sweet taste. The fruit extract is around 150-300 times sweeter than sugar, and has been used as a natural sweetener in China for nearly a millennium due to its flavour and low level of food energy.

It has surprisingly been found that the combination of these two sweeteners offers a sweetness profile which is closer to that of sucrose than either sweetener when taken alone. The sweetness profile is more rounded and the sweetness less lingering and less drying than is observed for either Stevia or LHG.

The extract from the fruit of the Cucurbitaceae family used in the invention will often comprises LHG. It is preferred that the extract from the leaves of the Stevia Rebaudiana plant or extract from the leaves of the Rubus suavissimus plant be a Stevia, most often the extract will comprise stevioside, rebaudioside A or a combination thereof.

The ratio of a:b in the sweetener composition will typically be in the range 60:40 or 70:30 to 90:10, in some embodiments in the range 75:25 to 80:20. The most preferred ratio is about 80:20. These ratios are preferred as it has been found that the sweetness profile is most like sucrose at these levels.

The sweetener composition of the invention has particular application in beverages, confectionery, and chewing gum. Often, the confectionery product will be a chocolate or candy based product.

The sweetener composition of the present invention may be used for full or partial replacement of sugar or artificial sweeteners.

### Steviosides

The sweetness profile of a Stevioside is slightly delayed and lingering and off-tastes are typically present in the form of bitterness and liquorice flavours.

Steviosides include stevioside, rebaudioside A, rebaudioside C, dulcoside A, rubusoside, steviolbioside, and rebaudioside B. Steviosides are sometimes known as glycosides of steviol or Stevia glycosides. Commercially, Steviosides are most often found in Stevia extract, which is obtained from the Stevia plant: Stevia rebaudiana (Bertoni) Bertoni of Compositae. Rubusoside can also be obtained from Rubus suavissimus S. Lee of Rosaceae.

A typical Stevia extract may contain about 50% to about 55% stevioside, about 20% to about 25% rebaudioside A, about 5% to about 10% rebaudioside C, and about 3 to about 5% dulcoside A. Stevia extract from Stevia plants which produce more rebaudioside A contain about 5% to about 14% stevioside, about 65% to about 72% rebaudioside A, about 3% to about 9% rebaudioside C, and about 0.6 to about 1.2% dulcoside A. Steviosides have a steviol backbone typically with glucose or rhamnose moieties. In certain embodiments the Steviosides comprises a Stevia extract. In another embodiment, the Stevia extract is about 5% to about 80% stevioside, or greater than 80% stevioside. In certain embodiments, the Stevia extract is about 20% to about 80% rebaudioside A, 98% rebaudioside A, or greater than 90% rebaudioside A. In other embodiments, the Stevia extract comprises 50-55% stevioside, 20-25% rebaudioside A, 5-10% rebaudioside C, and 3-5% dulcoside A; or 5-14% stevioside, 65-72% rebaudioside A, 3-9% rebaudioside C, and 0.6-1.2% dulcoside A.

Stevia extract can be purified to afford an array of sweeteners varied in the percentage purity of rebaudioside A or stevioside, and the present invention specifically contemplates the use of all such sweeteners comprising all percentages from 0% to 100% of rebaudioside A and stevioside and mixtures thereof.

The Steviosides of the invention also include those which have been extracted from nature and modified. One such example of modified extract is Enzyme Modified Stevia Extract (also called Sugar-Transferred Stevia Extract), whose glycosides have additional glucose units through actions by enzymes such as cyclomaltodextrin. As the invention aims to provide a natural combination of sweeteners, the use of modified Steviosides is generally not preferred.

As used herein, the term “extract from the leaves of the Stevia Rebaudiana plant” and the term “an extract from the leaves of the Rubus suavissimus plant” refers to extracts obtained from the Stevia rebaudiana (Bertoni) Bertoni of Compositae plant or the Rubus suavissimus S. Lee of Rosaceae plant respectively. Preferably, the extract will be a steviol glycoside, most preferably Stevia.

Although the following description of the products of this invention is described with particular reference to Stevia, other extracts of the Stevia Rebaudiana plant and the Rubus suavissimus plant are useful in this invention.

The extracts of the leaves of these plants may be used in the form of sweet juices, purees, solutions, pastes, or serums. The extract may alternatively be in the form of a solid, such as powders, granules, flakes, pellets, or any combination thereof. The solid form of the extract may be solvated with a suitable solvent such as water. The extracts may be in a diluted or concentrated form. The extracts may be used as a single strength juice or powder.

Alternatively, the extract may be in the form of a composition which comprises an amount of extract from the fruit in combination with other suitable ingredients or excipients. The composition may also be in the form of a solution that is formed from the addition of a sweet juice, puree, solution, paste, serums, or a solid of an extract of the leaves of the Stevia Rebaudiana plant or the Rubus suavissimus plant with a suitable solvent, such as water, for example.

Preferably the extract is in the form of a composition, said composition comprising a powdered extract which is solvated in a suitable solvent.

### Luo Han Guo

LHG has a highly distinctive flavour and intense sweetness allowing it to be used at very low levels in products, however LHG exhibits a slower sweetness onset than sucrose and the sweetness builds and lingers on the palate.

The compounds which provide the sweet taste of LHG comprise a group of triterpene glycosides including mogroside IV, mogroside V, 11-oxo-mogroside V and siamenoside I. The most abundant triterpene glycoside component of LHG is mogroside V. Mogroside V is reported to be 300 times sweeter than sucrose, and occurs in the fruit at concentrations up to 1% wt. Through extraction, a powder containing up to 80% mogrosides can be obtained. The chemical structure of mogroside V is shown below.

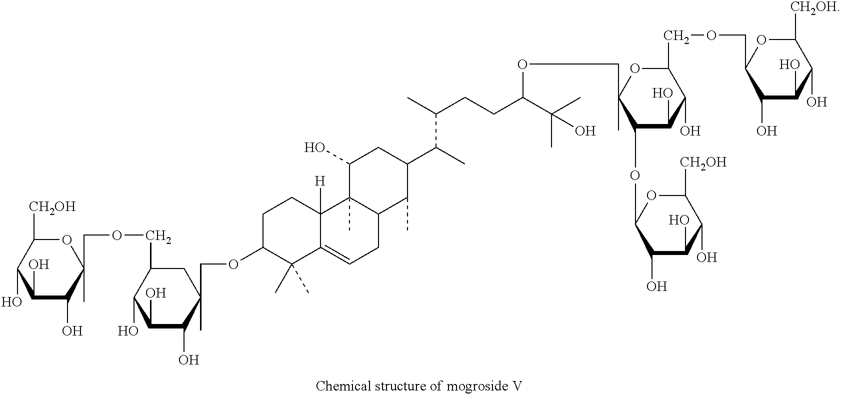

Agric. Biol. Chem., 53 (12). 33473349, 1989 Sweet Cucurbitane Glycosides from fruits of Siraitia siamensis (chi-zi-Lo-han-guo), a Chinese Folk Medicine by Ryoji KASAI, Rui-Lin Nie, Kenji NASHI, Kazuhiro OHTANI, Jun ZHOU, Guo-Da TAO and Osamu TANAKA describes a laboratory scale process for the isolation of various glycosides from LHG using chromotography on a highly porous polymer, then on silica gel and finally by HPLC (high performance liquid chromotography) on a reverse phase column.

Processing of LHG usually results in several non-sweet off flavours. These aromas have historically limited the use of the extracts as a sweetener to products that additionally have sugar or honey added to them, thereby masking the undesirable off flavours. The use of LHG as a natural high intensity sweetener is therefore typically limited for inclusion at low levels in soft drinks, and foodstuffs due to the very distinctive flavour.

LHG has been used in beverage formulations as an alternative sweetener to sucrose and artificial high intensity sweeteners but it is not necessarily used exclusively in low calorie drinks. In beverages, there is a move towards using natural sweeteners as an alternative to sucrose and artificial high intensity sweeteners, and therefore LHG is of interest for such a use.

As used herein, the term “an extract of a fruit from the Cucurbitaceae family” refers to extracts obtained from the plant of the family Cucurbitaceae, preferably tribe Jollifieae, more preferably sub-tribe Thladianthinae, and especially genus Siraitia. Especially preferred are the genus/species S. grosvenorii, S. siamensis, S. silomaradjae, S. sikkimensis, S. africana, S. borneensis, and S. taiwaniana. The most preferred fruit is the genus/species S. grosvenorii, which is often called Lo Han Guo fruit.

Although the following description of the products of this invention is described with particular reference to a LHG extract, other extracts of the Cucurbitaceae family which contain at least 0.01% sweet triterpene glycosides or mogrosides are useful in this invention. Preferably the extracts will contain more than 0.1% to about 15% mogrosides, preferably mogroside V, mogroside IV, 11-oxo-mogroside V, siamenoside 1 and mixtures thereof.

The extracts may be used in the form of sweet juices, purees, solutions, pastes, or serums. The extract may alternatively be in the form of a solid, such as powders, granules, flakes, pellets, or any combination thereof. The solid form of the extract may be solvated with a suitable solvent such as water. The extracts may be in a diluted or concentrated form. The extracts may be used as a single strength juice or powder.

Alternatively, the extract may be in the form of a composition which comprises an amount of extract from the fruit in combination with other suitable ingredients or excipients. The composition may also be in the form of a solution that is formed from the addition of a sweet juice, puree, solution, paste, serums or a solid of an extract of a fruit from the Cucurbitaceae family with a suitable solvent, such as water, for example.

Preferably the extract of a fruit from the Cucurbitaceae family is in the form of a composition, said composition comprising a powdered extract which is solvated in a suitable solvent.

### Optional Components

The sweetener composition may also additionally comprise at least one saccharide. It will be understood that this would include any suitable saccharide capable of being used in the sweetener composition in combination with the extract of the invention, and thereby facilitating reduction or masking of any bitter taste of the sweetener composition arising from the inclusion of the extracts from the leaves of the Stevia Rebaudiana plant, and/or the leaves of the Rubus suavissimus plant; and the fruit of the Cucurbitaceae family.

Saccharides, or sugars, are known in the art for providing sweet taste sensations for a consumer, thereby providing the sensation of sweetness to a foodstuff or composition to which they are added. Saccharides are based upon relatively simple carbohydrates comprising one or more monosaccharide units.

Suitable saccharides for the present invention include, by way of example, those selected from the groups comprising monosaccharides, disaccharides, and polysaccharides.

Suitable monosaccharides may be selected from the following groups:
Trioses—for example glyceraldehydes, or dihydroxyacetone
Tetroses—for example erythrose, threose, or erythrulose
Pentoses—for example arabinose, lyxose, ribose, xylose, ribulose, or xylulose
Hexoses—for example allose, altrose, galactose, glucose, glucose, idose, mannose, talose, fructose, psicose, sorbose, or tagatose
Heptoses—for example mannoheptulose, or sedoheptulose
Octoses—for example octolose, or 2-keto-3-deoxy-manno-octonate,
Nonoses—for example sialose.

Suitable disaccharides may be selected from, for example, sucrose, lactose, maltose, trehalose, or cellobiose.

Suitable polysaccharides include starch and glycogen.

Preferred saccharides are those selected from monosaccharides, and in particular those selected from the hexoses group. Particularly preferred monosaccharides are fructose.

The saccharides may be present in the range 0.01 wt. % to 10.0 wt. % of the sweetener composition. More preferably, the saccharides are present in the range 0.1 wt. % to 5.0 wt. %. Most preferably, the saccharides are present in the range 0.2 wt. % to 1.0 wt. %.

The saccharides may be used alone or in any suitable combination.

Sugar alcohols may also be present in the sweetener composition of the invention. It will be understood that this would include any suitable sugar alcohols capable of being used in the sweetener composition, and thereby facilitating reduction of the bitter taste of the sweetener composition.

Sugar alcohols are also known in the art as polyols, polyhydric alcohols, or polyalcohols. Sugar alcohols are a hydrogenated or partially hydrogenated form of carbohydrate in which the carbonyl group (aldehyde or ketone) is reduced to a primary or secondary hydroxyl group. Sugar alcohols may be used as replacements of sucrose in foodstuffs, and may be combined with high intensity artificial sweeteners (such as aspartame for example) to counter the low sweetness.

Suitable sugar alcohols may include those derived from disaccharides or monosaccharides.

Suitable sugar alcohols, by way of example, may include erythritol, isomalt, lactitol, maltitol, mannitol, sorbitol, xylitol, or any combination thereof.

Particularly preferred sugar alcohols include maltitol, and sorbitol.

However, it is preferred, where possible, that erythritol and/or the saccharide tagatose be absent from the composition, it is more preferred that the combination of erythritol and the saccharide tagatose be absent from the sweetener composition of the invention.

Specific examples of suitable alcohol sugars include, by way of example, C* Eridex (available commercially from Cargill of Mechelen, Belgium), Neosorb P60, Maltisorb P90, Xylisorb 90, Mannitol 60 (all available commercially from Roquette of Lestrem, France), Isomalt PF (available commercially from Palatinit of Germany), and Lactitol (available commercially from Danisco of Copenhagen, Denmark).

The sugar alcohols, where used, may be present in the range 0.1 wt. % to 10 wt. % of the sweetener composition. More preferably, the sugar alcohols are present in the range 0.5 wt. % to 5.0 wt. %. Most preferably, the sugar alcohols are present in the range 1.0 wt. % to 3.0 wt. %.

The sugar alcohols may be used alone or in any suitable combination. One preferred combination, by way of example, is sorbitol and maltitol.

The edible organic salts of monosaccaharide and disaccharide acids may also be present in the sweetener composition of the invention, they may comprise any such salts capable of being used in the flavour masking composition of the invention, and thereby facilitating reduction of the bitter taste of LHG. Suitable salts include, by way of example, salts of alkali metal and alkaline earth metal cations, such as calcium, sodium, magnesium, zinc, and potassium salts.

The preferred organic acid salts include salts of monocarboxylic organic acids. Salts of monocarboxylic acids having a carbon chain length from C1-C10 are preferred. Salts of monocarboxylic acids having a linear, optionally branched, backbone having a carbon chain length from C1-C10, and ideally from C1-C6, are most preferred.

Particularly preferred salts include at least one of a gluconate and/or a lactate.

Suitable salts include, by way of example, calcium lactate, magnesium lactate, sodium lactate, calcium gluconate, magnesium gluconate, and sodium gluconate. Magnesium gluconate is used in a preferred embodiment of the invention.

Specific examples of suitable organic salts for use in the invention include, by way of example, Gluconal KG, Puramex MG, Purasal-P, Purasal Hi-Pure P, and Purasal (all available commercially from Purac of Gorinchem, The Netherlands).

The salts of monocarboxylic acid and dicarboxylic acid, where present, may be present in the range from 0.001 wt. % to 1.0 wt. % of the sweetener composition. More preferably, these salts are present in the range from 0.005 wt. % to 0.1 wt. %. Most preferably, these salts are present in the range from 0.01 wt. % to 0.05 wt. %.

The salts of monocarboxylic acids and/or dicarboxylic acids may be used alone or in any suitable combination.

The salts of monocarboxylic acid and/or dicarboxylic acid and sugar alcohols may be used in the sweetener composition in any suitable combination. Suitable combinations include, by way of example, erythritol with sodium gluconate, erythritol with magnesium gluconate, erythritol with sodium lactate, malitol with magnesium gluconate, and malitol with sodium gluconate.

A particularly preferred combination of salt and sugar alcohol includes sorbitol with magnesium gluconate.

The sweetener composition of the present invention may be combined with additional ingredients such as flavouring systems.

The flavouring system may comprise flavours selected from fruit flavours, botanical flavours and mixtures thereof. Particularly preferred fruit flavours are the citrus flavours including orange flavours, lemon flavours, lime flavours and grapefruit flavours. In addition, a variety of other fruit flavours can be used such as apple flavours, grape flavours, cherry flavours, pineapple flavours and the like. These fruit flavours can be derived from natural sources such as fruit juices and flavour oils, or else be synthetically prepared.

The flavour component can comprise a blend of various flavours e.g. lemon and lime flavours, citrus flavours and selected spices (the typical cola soft drink flavour) etc. If desired, fruit juices such as orange juice, lemon juice, lime juice, apple juice, grape juice and the like can be used in the flavour component. The flavour in the flavour component is sometimes formed into emulsion droplets which may then be dispersed in a beverage drink. Because these droplets usually have a specific gravity less than that of water and would therefore form a separate phase, weighting agents (which can also act as clouding agents) are typically used to keep the emulsion droplets dispersed in the beverage. Examples of such weighting agents are brominated vegetable oils (BVO) and resin esters, and in particular ester gums.

The flavouring system may also comprise milk or milk type flavours.

The sweetener composition of the present invention may be blended with other juices and flavours to make low calorie beverages. Such other juices include apple, cranberry, pear, peach, plum, apricot, nectarine, grape, cherry, currant, raspberry, gooseberry, blackberry, blueberry, strawberry, lemon, orange, grapefruit, potato, tomato, lettuce, celery, spinach, cabbage, watercress, dandelion, rhubarb, carrot, beet, cucumber, pineapple, custard-apple, pomegranate, guanabana, kiwi, mango, papaya, banana, watermelon, passion fruit and cantaloupe. Preferred other juices are apple, pear, lemon, grapefruit, cranberry, orange, strawberry, grape, kiwi, pineapple, passion fruit, mango, guava, cherry, rosehips, lychee, water chestnuts and cane sugars. Citrus juices are preferred for blending with the sweetener composition of the present invention because of the high acidity of the citrus juice.

In addition to the flavouring systems and the sweetener composition of the present invention, the beverage or foodstuff (including chewing gum) may also comprise a mineral supplementation or a vitamin supplementation or mixtures thereof. The preferred mineral supplementation comprises calcium, potassium, magnesium, iron, sodium, or mixtures of these minerals. Amounts and methods for incorporation of the mentioned minerals are well known in the art. The level of the minerals is selected so as not to deteriorate the taste characteristics of the beverage composition.

Non-limiting representative flavour oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavourings are artificial, natural and synthetic fruit flavours such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavours include a milk flavour, a butter flavour, a cheese flavour, a cream flavour, and a yogurt flavour; a vanilla flavour; tea or coffee flavours, such as a green tea flavour, a oolong tea flavour, a tea flavour, a cocoa flavour, a chocolate flavour, and a coffee flavour; mint flavours, such as a peppermint flavour, a spearmint flavour, and a Japanese mint flavour; spicy flavours, such as an asafetida flavour, an ajowan flavour, an anise flavour, an angelica flavour, a fennel flavour, an allspice flavour, a cinnamon flavour, a camomile flavour, a mustard flavour, a cardamom flavour, a caraway flavour, a cumin flavour, a clove flavour, a pepper flavour, a coriander flavour, a sassafras flavour, a savoury flavour, a Zanthoxyli Fructus flavour, a perilla flavour, a juniper berry flavour, a ginger flavour, a star anise flavour, a horseradish flavour, a thyme flavour, a tarragon flavour, a dill flavour, a capsicum flavour, a nutmeg flavour, a basil flavour, a marjoram flavour, a rosemary flavour, a bayleaf flavour, and a wasabi (Japanese horseradish) flavour; alcoholic flavours, such as a wine flavour, a whisky flavour, a brandy flavour, a rum flavour, a gin flavour, and a liqueur flavour; floral flavours; and vegetable flavours, such as an onion flavour, a garlic flavour, a cabbage flavour, a carrot flavour, a celery flavour, mushroom flavour, and a tomato flavour.

These flavouring agents may be used in liquid or solid form and may be used individually or in admixture. Commonly used flavours include mints such as peppermint, menthol, spearmint, artificial vanilla, cinnamon derivatives, and various fruit flavours, whether employed individually or in admixture. Flavours may also provide breath freshening properties, particularly the mint flavours when used in combination with cooling agents.

In a particularly preferred embodiment of the invention, supplemented ascorbic acid (i.e. vitamin C) may be added in an amount of up to 0.15% of the beverage or foodstuff. Supplemented ascorbic acid is that which is added to the beverage or foodstuff and does not include that which may be incorporated by the flavouring system and the sweetener composition. Where added to a beverage, the ascorbic acid should be easily solubilised. It can be synthetic or natural, for example extracted from fruits or vegetables.

Other optional ingredients can be included in the beverages or foodstuffs of the invention. For example, preservatives, vitamins, pharmaceuticals, such as caffeine and antioxidants (polyphenols, for example), and other minerals can be included. Suitable vitamins include A, D, E, B1, B2, B6, B12, K, niacin, panthotenic acid, folic acid, biotin, and beta carotene. Other minerals which can be included are calcium, zinc, manganese, copper, and other trace minerals. If desired, natural and synthetic colourings can be included.

### Methods of Preparation

One aspect of the invention comprises a method of making a sweetener composition. The method preferably comprises combining an extract from the leaves of the Stevia Rebaudiana plant and/or an extract from the leaves of the Rubus suavissimus plant, with the extract from the fruit of the Cucurbitaceae family by mixing.

Each extract may preferably be the form of a sweet juice, solid, paste, puree, solution, serum, powder, granule, flake or pellet. The sweetener composition of the invention will often be prepared by mechanical mixing, spray drying or dissolution of both extracts in a single solvent. However, other techniques well known to the person skilled in the art may also be used.

Mixing will preferably be until the extract from the leaves of the Stevia Rebaudiana plant and/or the extract from the leaves of the Rubus suavissimus plant and the extract from the fruit of the Cucurbitaceae family are intimately combined and may occur at a raised temperature if appropriate.

### Uses

The edible sweetener composition of the present invention, especially when concentrated or dried, can be used as a sweetener for many purposes. Examples of such uses as a sweetener include addition to edible products such as; beverages, such as tea, coffee, sodas, carbonated beverages, non-carbonated beverages, fruit juice and fruit-flavoured beverages; foods, such as jams and jellies, peanut butter, pies, puddings, cereals, candies, confectionery, ice creams, yogurts, and popsicles; health care products, such as dentifrices, mouthwashes, cough drops, cough syrups; chewing gum, including dental chewing gum and bubble-gum; and also use generally as a sugar substitute.

Often the sweetener composition will be used in candy, chocolate, chocolate-style products, and chewing gum or combinations thereof.

Candy products are products which are generally primarily sugar based, for instance, chewy candy, hard boiled candy, jelly candy and other candies specific examples of which include caramel, toffee, fudge, praline, tablet, gumdrops, jelly beans, rock candy, lollipops, taffy, cotton candy, candy canes, peppermint sticks, peanut brittle, sucking candy and candy bars.

Chocolate products are those which are generally primarily cocoa based and include, for instance, white, milk and dark chocolate and products which are primarily formed of chocolate, for instance, products including dispersions of secondary ingredients such as fruit, nuts or nougat. Chocolate-style products include those made from chocolate alternatives such as carob.

Chewing gums may be in a variety of different shapes and product forms each of which may be coated or uncoated with a hard or soft shell. Examples include, sticks, slabs, chunks, balls, pillows, tablets, pellets, centre-filled compositions, pressed tablets, deposited or compressed.

Combination products would include, for instance, chocolate coated candies and candy centred chewing gums.

Use herein to the term “edible” means any substance suitable for use as a food, i.e. any substance that is eaten, drunk, or otherwise taken into the body.

Sweetener compositions of the present invention allow development of a reduced calorie beverage that is sweetened without the inclusion of synthetic high intensity sweeteners.

The edible product may preferably comprise the inventive sweetener composition in an amount from 0.001 to 10.0 wt %, more preferably in an amount from 0.5 to 5.0 wt % and most preferably in an amount from 1.0 to 4.0 wt %.

It is envisaged that the sweetener composition of the present invention may be used in the form of a sweet juice, puree, paste, solution, serum, or a solid (such as powders, granules, flakes, or pellets), which may be in a diluted or concentrated form.

The sweetener composition in the form of a sweet juice, puree, solution, paste, or serum may be dry treated to produce a solid form, such as a powder, granule, flake, or pellet, which is used in a foodstuff or beverage.

The edible product may be coated with the sweetener composition of the present invention for use in, for example, batters, frozen foods, sauces, fillings, and other nutritive ingredients. Examples of frozen foods include sauces, desserts, pastries and the like.

For the batters of cakes, cookies, breads, pastries and pie doughs the sweetener composition of the present invention may typically be included with water. The amounts of components and ingredients used in the batter composition are those amounts and ingredients typically used in preparing baked foods. The compositions can be prepared according to any methods.

### Use in Chewing Gum

As discussed previously, the invention has application in chewing gum technology.

The sweetener composition of the invention may be used as a bulk sweetener in chewing gum. For coated gums, the sweetener of the invention may additionally, or alternatively, be used in the coating. The sweetener composition of the invention may be used as the sole sweetener or alternatively in combination with one or more other sweeteners.

The elastomers (rubbers) employed in the gum base of the chewing gum will vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and combinations thereof. Examples of synthetic elastomers include, without limitation, styrene-butadiene copolymers (SBR), polyisobutylene, isobutylene-isoprene copolymers, polyethylene, polyvinyl acetate and the like, and combinations thereof. Specific examples of elastomers include polyisobutylene, styrene butadiene rubber, butyl rubber, and combinations thereof.

Additional useful polymers include: polybutylmethacrylate/acrylic acid copolymers, polyvinylacetate/vinylalcohol copolymers, microcrystalline cellulose, sodium carboxymethyl cellulose, hydroxylpropylmethyl cellulose, crosslinked cellulose acetate phthalate, crosslinked hydroxylmethyl cellulose polymers, zein, crosslinked polyvinyl pyrrolidone, polymethylmethacrylate/acrylic acid copolymers, copolymers of lactic acid, polyhydroxyalkanoates, plasticized ethylcellulose, polyvinyl acetatephthalate and combinations thereof.

In general, the elastomer employed in the gum base may have an average molecular weight of at least about 200,000. Desirably, the elastomer employed in the gum base has an average molecular weight from about 200,000 to about 2,000,000.

In some embodiments, it is particularly useful to include an elastomer composition including a predominant amount of a material selected from polyisobutylene, butyl rubber, butadiene-styrene rubber and combinations thereof, the elastomer composition having an average molecular weight of at least about 200,000; and a mastication processing aid, wherein the addition of the non-stick and/or degradability inducing component maintains the glass transition temperature of the elastomer within a three degree (3°) range, i.e., +/−three degrees. By “predominant” is meant that the composition includes greater than about 50% to about 98% of a material selected from polyisobutylene, butyl rubber, butadiene-styrene rubber and combinations thereof.

The amount of elastomer employed in the gum base may vary depending upon various factors such as the type of gum base used, the consistency of the gum composition desired and the other components used in the composition to make the final chewing gum product. In general, the elastomer may be present in the gum base in an amount from about 1% to about 30% by weight of the gum base. Desirably, the elastomer is present in an amount from about 2% to about 15% by weight of the gum base. More desirably, the elastomer is present in the gum base in an amount from about 3% to about 10% by weight of the gum base.

In some embodiments, the elastomer will be present in the gum base in an amount from about 10% to about 60% by weight, desirably from about 35% to about 40% by weight.

In some embodiments, the chewing gum base may include a texture-modifier. In general, the texture-modifier has a molecular weight of at least about 2,000.

In some embodiments, the texture-modifier includes a vinyl polymer. Suitable texture-modifiers include, for example, polyvinyl acetate, polyvinyl laurate acetate, polyvinyl alcohol or mixtures thereof.

Desirably, the texture-modifier is present in an amount from about 15% to about 70% by weight of the gum base. More desirably, the texture-modifier is present in an amount from about 20% to about 60% by weight of the gum base. Most desirably, the texture-modifier is present in an amount from about 30% to about 45% by weight of the gum base.

In addition to the components set out above, the gum base may include a variety of other ingredients, such as components selected from elastomer solvents, emulsifiers, plasticizers, fillers, and mixtures thereof. As mentioned above, the use of elastomer solvents is not needed to masticate the rubber during the manufacturing process. It may be present in limited amounts, but can lessen from the non-stick properties of the invention if used in amounts above about 5% by weight of the gum base. In certain embodiments of the invention, elastomer solvents may be used in amounts of about 4% to about 5% by weight of the gum base to provide non-stick properties which are sufficient to provide non-stick properties to teeth, dentures, oral implants and other oral prosthetics.

In some embodiments, the gum base may also contain less than conventional amounts of elastomer solvents to aid in softening the elastomer component. In particular, in some embodiments, such solvents are not required, but may be used in limited amounts along with the non-stick and/or degradability inducing components. By less than conventional amounts is meant that the elastomer solvent is employed in the gum base, for example, in amounts from about 0% to about 5.0% and preferably from about 0.1% to about 3.0%, by weight, of the gum base. In some embodiments, the gum base includes a maximum of about 5.0% by weight of an elastomer solvent. In other embodiments, the gum base is free of added elastomer solvents. In some embodiments the gum base is also free of added waxes.

In other embodiments, conventional amounts of elastomer solvents are incorporated in the gum bases to aid in softening the elastomer component.

Such elastomer solvents may include those elastomer solvents known in the art, for example, terpinene resins such as polymers of alpha-pinene or beta-pinene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof.

Desirably, the incorporation of an elastomer solvent in the gum base does not interfere with the non-stick inducing components of the gum base and/or with the ability of the gum base to degrade. In particular, in some embodiments where non-stickiness or reduced stickiness is desired, the elastomer solvent desirably softens the gum base without contributing to stickiness. Moreover, the Tg of the gum base desirably does not change more than +/− three (3°) upon incorporation of the elastomer solvent in the gum base in some embodiments where non-stickiness or reduced stickiness is desired.

In some embodiments, when a hydrophilic precursor component is incorporated into the inventive gum bases, an elastomer solvent may or may not be present. In particular, in some embodiments when a hydrophilic precursor component is used, the elastomer solvent is present is less than conventional amount, i.e., in amounts from about 0% to about 5% and preferably from about 0.1% to about 3%, by weight, of the gum base. In other embodiments when a hydrophilic precursor component is used, the elastomer solvent is present in conventional amounts, i.e., in amounts greater than about 5% by weight for the gum base. For example, the elastomer solvent may be present in an amount from about 2.0% to about 15% and, more particularly, from about 5% by weight to about 15% by weight of the gum base and, even more particularly, in amounts from about 7% by weight of the gum base to about 11% by weight of the gum base.

In some embodiments, the elastomer solvent employed may have at least one hydrophilic portion and at least one hydrophobic portion such that the hydrophilic portion orients inwardly within a gum base and such that the hydrophilic portion orients outwardly within a gum base made from elastomers. Suitable elastomer solvents having at least one hydrophilic portion and at least on hydrophobic portion include, for example, methyl ester liquid rosin. In some embodiments, it is especially useful to incorporate a methyl ester liquid rosin in relatively low amounts. Methyl ester liquid rosin interferes less with the non-stick and/or degradability inducing components as compared to other resins, but yet acts to increase softening of the gum base without contributing to increased stickiness when used in combination with the non-stick inducing component.

Desirably, in some embodiments, a methyl ester liquid rosin is incorporated in a gum base in an amount from about 0.5% by weight to about 5.0% by weight of the gum base. More desirably, a methyl ester liquid rosin is incorporated in a gum base in an amount from about 1.0% by weight to about 3.0% by weight of the gum base.

The gum base also may include emulsifiers which aid in dispersing the immiscible components of the gum base into a single stable system. The emulsifiers useful in this invention include glyceryl monostearate, lecithin, fatty acid monoglycerides, diglycerides, propylene glycol monostearate, and the like, and mixtures thereof. In some embodiments, the emulsifier may be employed in amounts from about 0% to about 50% and, more specifically, from about 2% to about 7%, by weight, of the gum base. In other embodiments, the emulsifier may be employed in amounts from about 2% to about 15% and, more specifically, from about 7% to about 11% by weight of the gum base.

The gum base also may include plasticizers or softeners to provide a variety of desirable textures and consistency properties. Because of the low molecular weight of these ingredients, the plasticizers and softeners are able to penetrate the fundamental structure of the gum base making it plastic and less viscous. Useful plasticizers and softeners include triacetin (glyceryl triacetate), lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, waxes, and the like, and mixtures thereof. Other softeners include carob, tragacanth, locust bean, and carboxymethyl cellulose. In some embodiments, the aforementioned plasticizers and softeners are generally employed in the gum base in amounts up to about 20% by weight of the gum base, and more specifically in amounts from about 2% to about 12%, by weight of the gum base. In other embodiments, the plasticizers and softeners are generally employed in the gum base in amounts up to about 20% by weight of the gum base and, more specifically, in amounts from about 9% to about 17% by weight of the gum base.

Plasticizers also include hydrogenated vegetable oils, such as soybean oil and cottonseed oils, which may be employed alone or in combination. These plasticizers provide the gum base with good texture and soft chew characteristics. These plasticizers and softeners are generally employed in amount from about 5% to about 14% and, more specifically, in amounts from about 5% to about 13.5%, by weight, of the gum base.

Suitable waxes, include for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof, and the like. Wax can be present in the gum base in an amount from about 1% to about 15% by weight of the gum base. In some embodiment, when used, the wax is desirably present in an amount from about 2% to about 10% by weight of the gum base and, more desirably, is present in an amount from about 3% to about 8% by weight of the gum base. In other embodiments when wax is used, the wax may be present in the gum base in an amount from about 6% to about 10% and, more desirably, from about 7% to about 9.5% by weight of the gum base.

In some embodiments, the gum base includes a maximum of about 8% of a wax. In other embodiments, the gum base is free of added wax.

In some embodiments when wax is present, the waxes employed may have a melting point below about 60° C. and, more desirably, between about 45° C. and about 55° C. The wax having a low melting point may be, for example, a paraffin wax.

In addition to low melting point waxes, in some embodiments, waxes having a higher melting point may be used in the gum base in amounts up to about 5% by weight of the gum base. Such high melting waxes include, for example, beeswax, vegetable wax, candelilla wax, carnuba wax, most petroleum waxes, and the like and mixtures thereof.

Anhydrous glycerin also may be employed as a softening agent, such as the commercially available United States Pharmacopeia (USP) grade. Glycerin is a syrupy liquid with a sweet warm taste and has a sweetness of about 60% of that of cane sugar. Because glycerin is hygroscopic, the anhydrous glycerin may be maintained under anhydrous conditions throughout the preparation of the chewing gum composition.

In some embodiments, the gum base of this invention may include bulking agents that are water-insoluble and/or mineral-based. In particular, the gum base of this invention also may include effective amounts of bulking agents such as mineral adjuvants which may serve as fillers and textural agents. Useful mineral adjuvants include calcium carbonate, magnesium carbonate, alumina, aluminium hydroxide, aluminium silicate, talc, starch, tricalcium phosphate, dicalcium phosphate, calcium sulfate, atomite, and the like, and mixtures thereof. These fillers or adjuvants may be used in the gum base compositions in various amounts. The filler may be present in an amount from about zero to about 60% by weight of the gum base and/or composition and, more specifically, from about zero to about 50% by weight and, even more specifically, from about zero to about 40%, by weight, of the gum base and/or chewing gum composition. In some embodiments, the filler may be present in an amount from about 0% by weight to about 30% by weight of the gum base and/or chewing gum composition. Moreover, in some embodiments, the amount of filler will be from about zero to about 15% by weight of the gum base and/or chewing gum composition and, more specifically, from about 3% to about 11%, by weight, of the gum base and/or chewing gum composition. In other embodiments, the amount of filler, when used, may be present in an amount from about 15% to about 40% and, desirably, from about 20% to about 30% by weight of the gum base.

In some embodiments, the gum base also may include at least one hydrophilic, water-absorbing polymer to help reduce the stickiness of the gum base and any resultant gum product made from the gum base. Suitable hydrophilic, water-absorbing polymers include the following: native and modified starches; chemically modified cellulose, including methyl cellulose, ethyl cellulose, carboxymethyl cellulose, hydroxypropyl cellulose; gums including xanthan gum, carrageenan gum, guar gum, gum arabic, locust bean gum, curdlan, arabinoxylan, agara, and alginates; and pectin and gelatin.

In general, at least one hydrophilic, water-absorbing polymer is included in an amount from about 0.1% to about 10% by weight of the gum base. Desirably, at least one hydrophilic, water-absorbing polymer is present in an amount from about 2% by weight to about 8% by weight of the gum base. More desirably, at least one hydrophilic, water-absorbing polymer is present in an amount from about 3% by weight to about 6% by weight of the gum base.

In some embodiments, at least one antioxidant may be present in the chewing gum bases. Desirably, the antioxidant is water-soluble. Suitable antioxidants include, for example, butylated hydroxytoluene (BHT), butylated hydroxyanisole (BHA), propyl gallate, vitamin C, vitamin E and mixtures thereof.

When an antioxidant is included in the gum base, the antioxidant is generally present in an amount from about 0.01% by weight to about 0.3% by weight of the gum base. Desirably, the antioxidant is included in the gum base in an amount from about 0.05% by weight to about 0.1% by weight of the gum base. When incorporated in embodiments together with the agent capable of degrading the elastomer, it is desirable to keep the antioxidant down to lower amounts to prevent any interference with free radicals which may be generated by photosensitizers.

In some embodiments, the chewing gum compositions include at least one elastomer and at least one agent capable of changing the molecular weight of the elastomer over time, such as by degrading the elastomer or increasing the molecular weight of the elastomer.

In some embodiments, a chewing gum base as discussed above may be incorporated in a chewing gum composition in an amount from about 5% by weight to about 95% by weight. More desirably, a chewing gum base may be present in an amount from about 28% by weight to about 42% by weight of the total chewing gum composition, and even more specifically, the range may be from about 28% to about 30% by weight of the total chewing gum composition. In the case of centre-filled chewing gum compositions, this weight percent may be based on the gum region rather than the centre-filled region.

The chewing gum compositions may include one or more bulk sweeteners in addition to the sweetener composition of the present invention, such as sugars, sugarless bulk sweeteners, or the like, or mixtures thereof. In some embodiments the total amount of bulk sweeteners is in the range from about 5% to about 99% by weight of the chewing gum composition.

Intense sweetening agents may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

In general, the total sweetener content is in an amount sufficient to provide the level of sweetness desired, and this amount may vary with the sweetener or combination of sweeteners selected. In general, sweetener is present in amounts from about 0.001% to about 3.0% by weight and, more specifically, from about 0.01% to about 2.0% by weight of the chewing gum composition.

The chewing gum compositions also may include flavours (i.e., flavourings or flavour agents). Flavours which may be used include those flavours known to the skilled artisan, such as natural and artificial flavours. These flavours may be chosen from synthetic flavour oils and flavouring aromatics and/or oils, oleoresins and extracts derived from plants, leaves, flowers, fruits, and so forth, and combinations thereof. Non-limiting representative flavour oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavourings are artificial, natural and synthetic fruit flavours such as vanilla, and citrus oils including lemon, orange, lime, grapefruit, yazu, sudachi, and fruit essences including apple, pear, peach, grape, strawberry, raspberry, cherry, plum, pineapple, watermelon, apricot, banana, melon, ume, cherry, raspberry, blackberry, tropical fruit, mango, mangosteen, pomegranate, papaya, and so forth. Other potential flavours include a milk flavour, a butter flavour, a cheese flavour, a cream flavour, and a yogurt flavour; a vanilla flavour; tea or coffee flavours, such as a green tea flavour, a oolong tea flavour, a tea flavour, a cocoa flavour, a chocolate flavour, and a coffee flavour; mint flavours, such as a peppermint flavour, a spearmint flavour, and a Japanese mint flavour; spicy flavours, such as an asafetida flavour, an ajowan flavour, an anise flavour, an angelica flavour, a fennel flavour, an allspice flavour, a cinnamon flavour, a camomile flavour, a mustard flavour, a cardamom flavour, a caraway flavour, a cumin flavour, a clove flavour, a pepper flavour, a coriander flavour, a sassafras flavour, a savoury flavour, a Zanthoxyli Fructus flavour, a perilla flavour, a juniper berry flavour, a ginger flavour, a star anise flavour, a horseradish flavour, a thyme flavour, a tarragon flavour, a dill flavour, a capsicum flavour, a nutmeg flavour, a basil flavour, a marjoram flavour, a rosemary flavour, a bayleaf flavour, and a wasabi (Japanese horseradish) flavour; alcoholic flavours, such as a wine flavour, a whisky flavour, a brandy flavour, a rum flavour, a gin flavour, and a liqueur flavour; floral flavours; and vegetable flavours, such as an onion flavour, a garlic flavour, a cabbage flavour, a carrot flavour, a celery flavour, mushroom flavour, and a tomato flavour. These flavours may be used in liquid or solid form and may be used individually or in admixture. Commonly used flavours include mints such as peppermint, menthol, spearmint, artificial vanilla, cinnamon derivatives, and various fruit flavours, whether employed individually or in admixture.

Other useful flavourings include aldehydes and esters such as cinnamyl acetate, cinnamaldehyde, citral diethylacetal, dihydrocarvyl acetate, eugenyl formate, p-methylamisol, and so forth may be used. Generally any flavouring or food additive such as those described in Chemicals Used in Food Processing, publication 1274, pages 63-258, by the National Academy of Sciences, may be used. This publication is incorporated herein by reference.

Further examples of aldehyde flavourings include but are not limited to acetaldehyde (apple), benzaldehyde (cherry, almond), anisic aldehyde (liquorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavours), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof.

In some embodiments, the flavour agent may be employed in either liquid form and/or dried form. When employed in the latter form, suitable drying means such as spray drying the oil may be used. Alternatively, the flavour agent may be absorbed onto water-soluble materials, such as cellulose, starch, sugar, maltodextrin, gum arabic and so forth or may be encapsulated. The actual techniques for preparing such dried forms are well-known.

In some embodiments of chewing gum, the flavour agents may be used in many distinct physical forms well-known in the art to provide an initial burst of flavour and/or a prolonged sensation of flavour. Without being limited thereto, such physical forms include free fauns, such as spray dried, powdered, beaded forms, encapsulated forms, and mixtures thereof.

The amount of flavour agent employed herein may be a matter of preference subject to such factors as the individual flavour and the strength of flavour desired. Thus, the amount of flavouring may be varied in order to obtain the result desired in the final product and such variations are within the capabilities of those skilled in the art without the need for undue experimentation. In general, the flavour agent is present in amounts from about 0.02% to about 5.0% by weight and, more specifically, from about 0.1% to about 4.0% by weight of the chewing gum product, and even more specifically, about 0.8% to about 3.0%

A variety of other traditional ingredients also may be included in the chewing gum products in effective amounts such as colouring agents, antioxidants, preservatives, and the like. Colouring agents may be used in amounts effective to produce the desired colour. The colouring agents may include pigments which may be incorporated in amounts up to about 6%, by weight of the composition. For example, titanium dioxide may be incorporated in amounts up to about 2%, and preferably less than about 1%, by weight of the composition. The colourants may also include natural food colours and dyes suitable for food, drug and cosmetic applications. These colourants are known as F.D. & C. dyes and lakes. The materials acceptable for the foregoing uses are preferably water-soluble. Illustrative non-limiting examples include the indigoid dye known as F.D. & C. Blue No. 2, which is the disodium salt of 5,5-indigotindisulfonic acid. Similarly, the dye known as F.D.& C. Green No. 1 comprises a triphenylmethane dye and is the monosodium salt of 4-[4-(N-ethyl-p-sulfoniumbenzylamino) diphenylmethylene]-[1-(N-ethyl-N-p-sulfoniumbenzyl)-delta-2,5-cyclohexadieneimine]. A full recitation of all F.D. & C. colourants and their corresponding chemical structures may be found in the Kirk-Othmer Encyclopaedia of Chemical Technology, 3rd Edition, in volume 5 at pages 857-884, which text is incorporated herein by reference.

Additional additives, such as sensates including physiological cooling agents; warming agents and tingling agents; throat-soothing agents; spices; herbs and herbal extracts, tooth-whitening agents; breath-freshening agents; vitamins and minerals; bioactive agents; caffeine; nicotine; drugs and other actives may also be included in any or all portions or regions of the chewing gum products. Such components may be used in amounts sufficient to achieve their intended effects.

With respect to cooling agents, a variety of well-known cooling agents may be employed. For example, among the useful cooling agents are included menthol, xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, 2-isopropanyl-5-methylcyclohexanol, hydroxycarboxylic acids with 2-6 carbon atoms, cyclohexanamides, menthyl acetate, menthyl lactate, methyl salicylate, N,2,3-trimethyl-2-isopropyl butanamide (WS-23), N-ethyl-p-menthane-3-carboxamide (WS-3), menthyl succinate, isopulegol, 3,1-menthoxypropane 1,2-diol, glutarate esters, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, trade name FRESCOLAT® type MGA); 3-1-menthoxypropane-1,2-diol (from Takasago, FEMA 3784); and menthyl lactate; (from Haarman & Reimer, FEMA 3748, trade name FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; and Menthol methyl ether, and menthyl pyrrolidone carboxylate among others, and combinations thereof. These and other suitable cooling agents are further described in the following U.S. patents, all of which are incorporated in their entirety by reference hereto: U.S. Pat. Nos. 4,230,688 and 4,032,661 to Rowsell et al.; 4,459,425 to Amano et al.; 4,136,163 to Watson et al.; 5,266,592 to Grub et al.; and U.S. Pat. No. 6,627,233 to Wolf et al. Cooling agents are generally present in amount of 0.01% to about 10.0%.

Warming agents may be selected from a wide variety of compounds known to provide the sensory signal of warming to the individual user. These compounds offer the perceived sensation of warmth, particularly in the oral cavity, and often enhance the perception of flavours, sweeteners and other organoleptic components. Useful warming agents include those having at least one allyl vinyl component, which may bind to oral receptors. Examples of suitable warming agents include, but are not limited to: vanillyl alcohol n-butylether (TK-1000, supplied by Takasago Perfumery Company Ltd., Tokyo, Japan); vanillyl alcohol n-propylether; vanillyl alcohol isopropylether; vanillyl alcohol isobutylether; vanillyl alcohol n-aminoether; vanillyl alcohol isoamylether; vanillyl alcohol n-hexylether; vanillyl alcohol methylether; vanillyl alcohol ethylether; gingerol; shogaol; paradol; zingerone; capsaicin; dihydrocapsaicin; nordihydrocapsaicin; homocapsaicin; homodihydrocapsaicin; ethanol; isopropyl alcohol; iso-amylalcohol; benzyl alcohol; glycerine; chloroform; eugenol; cinnamon oil; cinnamic aldehyde; phosphate derivatives thereof; and combinations thereof.

Tingling agents may provide a tingling, stinging or numbing sensation to the user. Tingling agents include, but are not limited to: Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; black pepper extract (piper nigrum), including the active ingredients chavicine and piperine; Echinacea extract; Northern Prickly Ash extract; and red pepper oleoresin. In some embodiments, alkylamides extracted from materials such as jambu or sanshool may be included. Additionally, in some embodiments, a sensation is created due to effervescence. Such effervescence is created by combining an alkaline material with an acidic material, either or both of which may be encapsulated. In some embodiments, an alkaline material may include alkali metal carbonates, alkali metal bicarbonates, alkaline earth metal carbonates, alkaline earth metal bicarbonates and mixtures thereof. In some embodiments, an acidic material may include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. Examples of “tingling” type sensates can be found in U.S. Pat. No. 6,780,443, the entire contents of which are incorporated herein by reference for all purposes. Tingling agents are described in U.S. Pat. No. 6,780,443 to Nakatsu et al., U.S. Pat. No. 5,407,665 to McLaughlin et al., U.S. Pat. No. 6,159,509 to Johnson et al. and U.S. Pat. No. 5,545,424 to Nakatsu et al., each of which is incorporated by reference herein in its entirety.

The sensation of warming or cooling effects may be prolonged with the use of a hydrophobic sweetener as described in U.S. Patent Application Publication 2003/0072842 A1 to Johnson et al. which is incorporated in its entirety herein by reference. For example, such hydrophobic sweeteners include those of the formulae I-XI referenced therein. Perillartine may also be added as described in U.S. Pat. No. 6,159,509 also incorporated in its entirety herein by reference.

Breath-freshening agents, in addition to the flavours and cooling agents described hereinabove, may include a variety of compositions with odour-controlling properties. Such breath-freshening agents may include, without limitation, cyclodextrin and magnolia bark extract. The breath-freshening agents may further be encapsulated to provide a prolonged breath-freshening effect. Examples of malodour-controlling compositions are included in U.S. Pat. No. 5,300,305 to Stapler et al. and in U.S. Patent Application Publication Nos. 2003/0215417 and 2004/0081713, which are incorporated in their entirety herein by reference.

A variety of oral care products also may be included in some embodiments of the instant chewing gum compositions. Such oral care products may include tooth whiteners, stain removers, anti-calculus agents, and anti-plaque agents. Oral care agents that may be used include those actives known to the skilled artisan, such as, but not limited to, surfactants, breath-freshening agents, anti-microbial agents, antibacterial agents, oral malodour control agents, fluoride compounds, quaternary ammonium compounds, remineralisation agents and combinations thereof. Examples of these include, but are not limited to hydrolytic agents including proteolytic enzymes, abrasives such as hydrated silica, calcium carbonate, sodium bicarbonate and alumina, other active stain-removing components such as surface-active agents, such as anionic surfactants such as sodium stearate, sodium palminate, sulfated butyl oleate, sodium oleate, salts of fumaric acid, glycerol, hydroxylated lecithin, sodium lauryl sulfate and chelators such as polyphosphates, which are typically employed in dentifrice compositions as tartar control ingredients. Also included are tetrasodium pyrophosphate and sodium tri-polyphosphate, sodium tripolyphosphate, xylitol, hexametaphosphate, and an abrasive silica. Further examples are included in the following U.S. patents which are incorporated in their entirety herein by reference: U.S. Pat. Nos. 5,227,154 to Reynolds, 5,378,131 to Greenberg and 6,685,916 to Holme et al. Suitable oral care actives such as remineralisation agents, antimicrobials, and tooth-whitening agents are described in assignee's co-pending U.S. patent application Ser. No. 10/901,511, filed Jul. 29, 2004 and entitled “Tooth-Whitening Compositions and Delivery Systems Therefore,” which is incorporated herein by reference in its entirely, and the like, and mixtures thereof.

A variety of drugs, including medications, herbs, and nutritional supplements may also be included in the chewing gum compositions. Examples of useful drugs include ace-inhibitors, antianginal drugs, anti-arrhythmias, anti-asthmatics, anti-cholesterolemics, analgesics, anesthetics, anti-convulsants, anti-depressants, anti-diabetic agents, anti-diarrhoea preparations, antidotes, anti-histamines, anti-hypertensive drugs, anti-inflammatory agents, anti-lipid agents, anti-manics, anti-nauseants, anti-stroke agents, anti-thyroid preparations, anti-tumour drugs, anti-viral agents, acne drugs, alkaloids, amino acid preparations, anti-tussives, anti-uricemic drugs, anti-viral drugs, anabolic preparations, systemic and non-systemic anti-infective agents, anti-neoplastics, anti-parkinsonian agents, anti-rheumatic agents, appetite stimulants, biological response modifiers, blood modifiers, bone metabolism regulators, cardiovascular agents, central nervous system stimulates, cholinesterase inhibitors, contraceptives, decongestants, dietary supplements, dopamine receptor agonists, endometriosis management agents, enzymes, erectile dysfunction therapies such as sildenafil citrate, which is currently marketed as Viagra®, fertility agents, gastrointestinal agents, homeopathic remedies, hormones, hypercalcemia and hypocalcaemia management agents, immunomodulators, immunosuppressives, migraine preparations, motion sickness treatments, muscle relaxants, obesity management agents, osteoporosis preparations, oxytocics, parasympatholytics, parasympathomimetics, prostaglandins, psychotherapeutic agents, respiratory agents, sedatives, smoking cessation aids such as bromocryptine or nicotine, sympatholytics, tremor preparations, urinary tract agents, vasodilators, laxatives, antacids, ion exchange resins, anti-pyretics, appetite suppressants, expectorants, anti-anxiety agents, anti-ulcer agents, anti-inflammatory substances, coronary dilators, cerebral dilators, peripheral vasodilators, psycho-tropics, stimulants, anti-hypertensive drugs, vasoconstrictors, migraine treatments, antibiotics, tranquilizers, anti-psychotics, anti-tumour drugs, anti-coagulants, anti-thrombotic drugs, hypnotics, anti-emetics, anti-nauseants, anti-convulsants, neuromuscular drugs, hyper- and hypo-glycemic agents, thyroid and anti-thyroid preparations, diuretics, anti-spasmodics, terine relaxants, anti-obesity drugs, erythropoietic drugs, anti-asthmatics, cough suppressants, mucolytics, DNA and genetic modifying drugs, and combinations thereof.

Examples of active ingredients contemplated for use in the present inventive chewing gum compositions include antacids, H2-antagonists, and analgesics. For example, antacid dosages can be prepared using the ingredients calcium carbonate alone or in combination with magnesium hydroxide, and/or aluminium hydroxide. Moreover, antacids can be used in combination with H2-antagonists.

Analgesics include opiates and opiate derivatives, such as Oxycontin, ibuprofen, aspirin, acetaminophen, and combinations thereof that may optionally include caffeine.

Other drug ingredients for use in embodiments include anti-diarrhoeal such as immodium AD, anti-histamines, anti-tussives, decongestants, vitamins, and breath-fresheners. Also contemplated for use herein are anxiolytics such as Xanax; anti-psychotics such as clozaril and Haldol; non-steroidal anti-inflammatories (NSAID's) such as ibuprofen, naproxen sodium, Voltaren and Lodine, anti-histamines such as Claritin, Hismanal, Relafen, and Tavist; anti-emetics such as Kytril and Cesamet; bronchodilators such as Bentolin, Proventil; anti-depressants such as Prozac, Zoloft, and Paxil; anti-migraines such as Imigra, ACE-inhibitors such as Vasotec, Capoten and Zestril; anti-Alzheimer's agents, such as Nicergoline; and CaH-antagonists such as Procardia, Adalat, and Calan.

Moreover, some embodiments of chewing gum compositions can include H2-antagonists. Examples of suitable H2-antagonist include cimetidine, ranitidine hydrochloride, famotidine, nizatidien, ebrotidine, mifentidine, roxatidine, pisatidine and aceroxatidine.

Active antacid ingredients include, but are not limited to, the following: aluminium hydroxide, dihydroxyaluminium aminoacetate, aminoacetic acid, aluminium phosphate, dihydroxyaluminum sodium carbonate, bicarbonate, bismuth aluminate, bismuth carbonate, bismuth subcarbonate, bismuth subgallate, bismuth subnitrate, bismuth subsilysilate, calcium carbonate, calcium phosphate, citrate ion (acid or salt), amino acetic acid, hydrate magnesium aluminate sulfate, magaldrate, magnesium aluminosilicate, magnesium carbonate, magnesium glycinate, magnesium hydroxide, magnesium oxide, magnesium trisilicate, milk solids, aluminium mono-ordibasic calcium phosphate, tricalcium phosphate, potassium bicarbonate, sodium tartrate, sodium bicarbonate, magnesium aluminosilicates, tartaric acids and salts.

A variety of other nutritional supplements also may be included in the gum compositions. Virtually any vitamin or mineral may be included. For example, vitamin A, vitamin C, vitamin D, vitamin E, vitamin K, vitamin B₆, vitamin B₁₂, thiamine, riboflavin, biotin, folic acid, niacin, pantothenic acid, sodium, potassium, calcium, magnesium, phosphorus, sulfur, chlorine, iron, copper, iodine, zinc, selenium, manganese, choline, chromium, molybdenum, fluorine, cobalt and combinations thereof, may be used.

Examples of nutritional supplements are set forth in U.S. Patent Application Publication Nos. 2003/0157213 A1, 2003/0206993 and 2003/0099741 A1, which are incorporated in their entirety herein by reference.

Various herbs also may be included such as those with various medicinal or dietary supplement properties. Herbs are generally aromatic plants or plant parts that can be used medicinally or for flavouring. Suitable herbs can be used singly or in various mixtures. Commonly used herbs include Echinacea, Goldenseal, Calendula, Aloe, Blood Root, Grapefruit Seed Extract, Black Cohosh, Cranberry, Ginko Biloba, St. John's Wort, Evening Primrose Oil, Yohimbe Bark, Green Tea, Maca, Bilberry, Lutein, and combinations thereof.

Acidulants also may be included in the chewing gum compositions. Suitable acidulants include, for example, malic acid, adipic acid, citric acid, tartaric acid, fumaric acid, and mixtures thereof.

Any of the aforementioned additives for use in a chewing gum composition, as well as other conventional additives known to one having ordinary skill in the art, such as thickeners, may be incorporated into the chewing gum base of the chewing gum compositions or any coating that the chewing gum product may contain.

The chewing gum compositions may be formed into a variety of shapes and sizes and may take various product forms, including without limitation, sticks, slabs, chunks, balls, pillows, tablet, pellet, centre-filled, pressed tablet, deposited, compressed chewing gum or any other suitable format, as well as coated and uncoated forms.

When the chewing gum compositions are formed into coated products, the coating may be applied by any method known in the art. The coating composition may be present in an amount from about 2% to about 60%, more specifically from about 25% to about 35% by weight of the total centre-filled gum piece or from about 25% to about 45% by weight of the total chewing gum piece and even more specifically, in an amount about 30% by weight of the gum piece.

Such coated chewing gums are typically referred to as pellet gums. The outer coating may be hard or crunchy. Any suitable coating materials known to those skilled in the art may be employed. Typically, the outer coating may include the sweetener composition of the present invention, optionally in combination with any of sorbitol, maltitol, xylitol, isomalt, erythritol, isomalt, and other crystallisable polyols; sucrose may also be used. Furthermore, the coating may include several opaque layers, such that the chewing gum composition is not visible through the coating itself, which can optionally be covered with a further one or more transparent layers for aesthetic, textural and protective purposes. The outer coating may also contain small amounts of water and gum arabic. The coating can be further coated with wax. The coating may be applied in a conventional manner by successive applications of a coating solution, with drying in between each coat. As the coating dries it usually becomes opaque and is usually white, though other colourants may be added. A polyol coating can be further coated with wax. The coating can further include coloured flakes or speckles. If the composition includes a coating, it is possible that one or more oral care actives can be dispersed throughout the coating. This is especially preferred if one or more oral care actives is incompatible in a single phase composition with another of the actives. Flavours may also be added to yield unique product characteristics.

Other materials may be added to the coating to achieve desired properties. These materials may include, without limitations, cellulosics such as carboxymethyl cellulose, gelatin, xanthan gum, and gum arabic.

In the case of centre-filled chewing gum products, the coating may also be formulated to assist with increasing the thermal stability of the gum piece and preventing leaking of the liquid fill. In some embodiments, the coating may include a gelatin composition. The gelatin composition may be added as a 40% by weight solution and may be present in the coating composition from about 5% to about 10% by weight of the coating composition, and more specifically about 7% to about 8%. The gel strength of the gelatin may be from about 130 bloom to about 250 bloom.

Other materials may be added to the coating to achieve desired properties. These materials may include without limitations, cellulosics such as carboxymethyl cellulose, gelatin, pullulan, alginate, starch, carrageenan, xanthan gum, gum arabic and polyvinyl acetate (PVA).

The coating composition may also include a pre-coating which is added to the individual gum pieces prior to an optional hard coating. The pre-coating may include an application of polyvinyl acetate (PVA). This may be applied as a solution of PVA in a solvent, such as ethyl alcohol. When an outer hard coating is desired, the PVA application may be approximately 3% to 4% by weight of the total coating or about 1% of the total weight of the gum piece (including a liquid-fill, gum region and hard coating).

Some embodiments extend to methods of processing an elastomer in a gum base. In particular, some embodiments extend to methods of processing an elastomer for use in a gum base without substantially changing the Tg of the gum base as measured by differential scanning calorimetry (DSC). Such methods include the step of mixing at least one elastomer and at least one fat.

Differential scanning calorimetry (DSC) is a thermoanalytical technique in which the difference in the amount of heat required to increase the temperature of a sample and reference are measured as a function of temperature. The basic principle underlying this technique is that, when the sample undergoes a physical transformation such as phase transitions, more (or less) heat will need to flow to it than the reference to maintain both at the same temperature. Whether more or less heat must flow to the sample depends on whether the process is exothermic or endothermic. For example, as a solid sample melts to a liquid it will require more heat flowing to the sample to increase its temperature at the same rate as the reference. This is due to the absorption of heat by the sample as it undergoes the endothermic phase transition from solid to liquid. Likewise, as the sample undergoes exothermic processes (such as crystallization) less heat is required to raise the sample temperature. By observing the difference in heat flow between the sample and reference, differential scanning calorimeters are able to measure the amount of energy absorbed or released during such transitions. DSC is used to observe more subtle phase changes, such as glass transitions.

Other embodiments extend to methods of processing a solid elastomer that include: providing a solid elastomer composition suitable for use in a chewing gum base and combining with the solid elastomer composition a non-stick and/or degradability inducing component including at least one fat having an HLB range of about 3.5 to about 13. In such methods, the non-stick and/or degradability inducing component is present in amounts sufficient to permit mastication of the solid elastomer composition into a homogenous mass.

In some embodiments, the above-described methods of processing an elastomer are carried out in the presence of very low amounts of elastomer solvent. In such embodiments, the elastomer solvent includes a maximum of about 5.0% of any gum base made by masticating an elastomer as described above.

In other embodiments, the above-described methods of processing an elastomer are carried out in the absence of added elastomer solvent.

Some embodiments extend to methods of making a chewing gum base. In some embodiments, the methods of making a chewing gum base include providing at least one elastomer and mixing at least one non-stick and/or degradability inducing component with the elastomer to form a chewing gum base, wherein the at least one non-stick and/or degradability inducing component softens the elastomer without causing the chewing gum base to become sticky. In such embodiments, the chewing gum base has reduced stickiness in the presence of the non-stick and/or degradability inducing component as compared to in the absence of the non-stick and/or degradability inducing component.

In additional embodiments, the methods of making a chewing gum base include processing an elastomer for use in a gum base without substantially changing the Tg of the gum base as measured by DSC by mixing at least one elastomer and at least one fat or oil.

Moreover, in further embodiments, the methods of making a chewing gum base include providing a solid elastomer composition suitable for use in a chewing gum base and combining with the solid elastomer composition a non-stick and/or degradability inducing component that includes at least one fat or oil having an HLB range of about 3.5 to about 13. In such methods, the non-stick and/or degradability inducing component is present in amounts sufficient to permit processing of the solid elastomer composition into a softened, processable mass.

In some embodiments, the above-described methods of making a chewing gum base may be carried out in the presence of lower than conventional amounts of elastomer solvent. In such embodiments, the elastomer solvent includes a maximum of about 5.0% of the gum base. Desirably, an elastomer solvent can be mixed with an elastomer and non-stick and/or degradability inducing component to soften the elastomer without causing the resultant chewing gum base to become sticky.

In other embodiments, the above-described methods of making a chewing gum base are carried out in the absence of added elastomer solvent.

The manner in which the gum base components are mixed is not critical and such mixing is performed using standard apparatuses known to those skilled in the art. In a typical method, at least one elastomer is admixed with at least one mastication processing aid, which for purposes of the invention includes one or more non-stick and/or degradability inducing components, and agitated for a period of from 1 to 30 minutes. The remaining ingredients, such as the texture-modifier and/or softener are then admixed, either in bulk or incrementally, while the gum base mixture is blended again for 1 to 30 minutes.

The products may be prepared using standard techniques and equipment known to those skilled in the art, which processes generally involve melting the gum base, incorporating the desired ingredients while mixing and forming the batch into individual chewing gum pieces. The apparatus useful in accordance with the embodiments described herein includes mixing and heating apparatuses well-known in the chewing gum manufacturing arts, and therefore the selection of the specific apparatus will be apparent to the artisan. For general chewing gum preparation processes which are useful in some embodiments see U.S. Pat. Nos. 4,271,197 to Hopkins et al., 4,352,822 to Cherukuri et al. and 4,497,832 to Cherukuri et al., each of which is incorporated herein by reference in its entirety.

For instance, centre-fill chewing gum embodiments may include a centre-fill region, which may be a liquid or powder or other solid, and a gum region. Some embodiments also may include an outer gum coating or shell, which typically provides a crunchiness to the piece when initially chewed. The outer coating or shell may at least partially surround the gum region.

Some other chewing gum embodiments may be in a compressed gum foi mat, such as, for example, a pressed tablet gum. Such embodiments may include a particulate chewing gum base, which may include a compressible gum base composition and a tableting powder.

Use in Combination with a Taste Potentiator

The sweetener compositions of the invention may be used in combination with a taste potentiator, for example in beverages. Such compositions would include the sweetener composition of the invention, as at least one active ingredient substance, and optionally one or more other ingredients and a taste potentiator which may increase the perception of the active substance.

In some embodiments, the active substance(s) included in the potentiator compositions may be present in amounts of about 1% to about 95% by weight of the composition, more specifically about 5% to about 30% by weight of the composition.

Any of a variety of substances that function as taste potentiators may be employed in the compositions described herein. For instance, suitable taste potentiators include water-soluble taste potentiators, such as, but not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), water-soluble sugar acids, potassium chloride, sodium acid sulfate, water-soluble hydrolyzed vegetable proteins, water-soluble hydrolyzed animal proteins, water-soluble yeast extracts, adenosine monophosphate (AMP), glutathione, water-soluble nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, 2-hydroxybenzoic acid (2-HB), 3-hydroxybenzoic acid (3-HB), 4-hydroxybenzoic acid (4-HB), 2,3-dihydroxybenzoic acid (2,3-DHB), 2,4-dihydroxybenzoic acid (2,4-DHB), 2,5-dihydroxybenzoic acid (2,5-DHB), 2,6-dihydroxybenzoic acid (2,6-DHB), 3,4-dihydroxybenzoic acid (3,4-DHB), 3,5-dihydroxybenzoic acid (3,5-DHB), 2,3,4-trihydroxybenzoic acid (2,3,4-THB), 2,4,6-trihydroxybenzoic acid (2,4,6-THB), 3,4,5-trihydroxybenzoic acid (3,4,5-THB), 4-hydroxyphenylacetic acid, 2-hydroxyisocaproic acid, 3-hydroxycinnamic acid, 3-aminobenzoic acid, 4-aminobenzoic acid, 4-methoxysalicylic acid and combinations thereof.

The active substance(s) may comprise any component for which the perception is enhanced in some manner by the presence of one or more taste potentiators. Suitable active substances include, but are not limited to, compounds that provide flavour, sweetness, tartness, umami, kokumi, savoury, saltiness, cooling, warmth or tingling. Other suitable actives include oral care agents, nutraceutical actives and pharmaceutical actives. Combinations of active substances also may be employed.

Compounds that provide flavour (flavourings or flavour agents), which may be used include those flavours known to the skilled artisan, such as natural and artificial flavours. These flavourings may be chosen from synthetic flavour oils and flavouring aromatics and/or oils, oleoresins and extracts derived from plants, leaves, flowers, fruits, and so forth, and combinations thereof. Non-limiting representative flavour oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavourings are artificial, natural and synthetic fruit flavours such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavours include a milk flavour, a butter flavour, a cheese flavour, a cream flavour, and a yogurt flavour; a vanilla flavour; tea or coffee flavours, such as a green tea flavour, a oolong tea flavour, a tea flavour, a cocoa flavour, a chocolate flavour, and a coffee flavour; mint flavours, such as a peppermint flavour, a spearmint flavour, and a Japanese mint flavour; spicy flavours, such as an asafetida flavour, an ajowan flavour, an anise flavour, an angelica flavour, a fennel flavour, an allspice flavour, a cinnamon flavour, a camomile flavour, a mustard flavour, a cardamom flavour, a caraway flavour, a cumin flavour, a clove flavour, a pepper flavour, a coriander flavour, a sassafras flavour, a savoury flavour, a Zanthoxyli Fructus flavour, a perilla flavour, a juniper berry flavour, a ginger flavour, a star anise flavour, a horseradish flavour, a thyme flavour, a tarragon flavour, a dill flavour, a capsicum flavour, a nutmeg flavour, a basil flavour, a marjoram flavour, a rosemary flavour, a bayleaf flavour, and a wasabi (Japanese horseradish) flavour; alcoholic flavours, such as a wine flavour, a whisky flavour, a brandy flavour, a rum flavour, a gin flavour, and a liqueur flavour; floral flavours; and vegetable flavours, such as an onion flavour, a garlic flavour, a cabbage flavour, a carrot flavour, a celery flavour, mushroom flavour, and a tomato flavour. These flavouring agents may be used in liquid or solid form and may be used individually or in admixture. Commonly used flavours include mints such as peppermint, menthol, spearmint, artificial vanilla, cinnamon derivatives, and various fruit flavours, whether employed individually or in admixture. Flavours may also provide breath freshening properties, particularly the mint flavours when used in combination with cooling agents.

Other useful flavourings include aldehydes and esters such as cinnamyl acetate, cinnamaldehyde, citral diethylacetal, dihydrocarvyl acetate, eugenyl formate, p-methylamisol, and so forth may be used. Generally any flavouring or food additive such as those described in Chemicals Used in Food Processing, publication 1274, pages 63-258, by the National Academy of Sciences, may be used. This publication is incorporated herein by reference.

Further examples of aldehyde flavourings include but are not limited to acetaldehyde (apple), benzaldehyde (cherry, almond), anisic aldehyde (liquorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavours), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof.

In some embodiments, the flavour agent may be employed in either liquid form and/or dried form. When employed in the latter form, suitable drying means such as spray drying the oil may be used. Alternatively, the flavour agent may be absorbed onto water soluble materials, such as cellulose, starch, sugar, maltodextrin, gum arabic and so forth or may be encapsulated. The actual techniques for preparing such dried forms are well-known.

In some embodiments, the flavour agents may be used in many distinct physical forms well-known in the art to provide an initial burst of flavour and/or a prolonged sensation of flavour. Without being limited thereto, such physical forms include free forms, such as spray dried, powdered, beaded forms, encapsulated forms, and mixtures thereof.

Compounds that provide sweetness (sweeteners or sweetening agents) may be included in addition to the sweetener compositions of the invention. These may include additional bulk sweeteners such as sugars, sugarless bulk sweeteners, or the like, or mixtures thereof.

Intense sweetening agents may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

Compounds that provide tartness may include acidulants, such as acetic acid, adipic acid, ascorbic acid, butyric acid, citric acid, formic acid, fumaric acid, glyconic acid, lactic acid, phosphoric acid, malic acid, oxalic acid, succinic acid, tartaric acid and mixtures thereof.

Compounds that provide umami or savoury flavour may include monosodium glutamate (MSG), glutamic acid, glutamates, aspartate, free amino acids, IMP (disodium 5′-inosine monophosphate) and GMP (disodium 5′-guanosine monophosphate), compounds that stimulate T1R1 and T1R3 receptors, mushroom flavour, fermented fish flavour, and muscle flavours, such as beef, chicken, pork, ostrich, venison and buffalo.

Substances that impart kokumi may include a mixture selected from: (1) gelatin and tropomyosin and/or tropomyosin peptides; (2) gelatin and paramyosin; and (3) troponin and tropomyosin and/or tropomyosin peptides, as disclosed in U.S. Pat. No. 5,679,397 to Kuroda et al., referred to above.

Compounds that provide saltiness may include conventional salts, such as sodium chloride, calcium chloride, potassium chloride, 1-lysine and combinations thereof.

Compounds that provide a cooling sensation may include physiological cooling agents. A variety of well known cooling agents may be employed. For example, among the useful cooling agents are included xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from: Hisamitsu Pharmaceuticals, hereinafter “isopregol”); menthone glycerol ketals (FEMA 3807, trade name FRESCOLAT® type MGA); 3-1-menthoxypropane-1,2-diol (from Takasago, FEMA 3784); and menthyl lactate; (from Haarman & Reimer, FEMA 3748, trade name FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

Compounds that provide warmth (warming agents) may be selected from a wide variety of compounds known to provide the sensory signal of warming to the individual user. These compounds offer the perceived sensation of warmth, particularly in the oral cavity, and often enhance the perception of flavours, sweeteners and other organoleptic components. Useful warming agents include those having at least one allyl vinyl component, which may bind to oral receptors. Examples of suitable warming agents include, but are not limited to: vanillyl alcohol n-butylether (TK-1000, supplied by Takasago Perfumery Company Ltd., Tokyo, Japan); vanillyl alcohol n-propylether; vanillyl alcohol isopropylether; vanillyl alcohol isobutylether; vanillyl alcohol n-aminoether; vanillyl alcohol isoamylether; vanillyl alcohol n-hexylether; vanillyl alcohol methylether; vanillyl alcohol ethylether; gingerol; shogaol; paradol; zingerone; capsaicin; dihydrocapsaicin; nordihydrocapsaicin; homocapsaicin; homodihydrocapsaicin; ethanol; isopropyl alcohol; iso-amylalcohol; benzyl alcohol; glycerine; chloroform; eugenol; cinnamon oil; cinnamic aldehyde; phosphate derivatives thereof; and combinations thereof.

Compounds that provide a tingling sensation also are known and referred to as “tingling agents.” Tingling agents may be employed to provide a tingling, stinging or numbing sensation to the user. Tingling agents include, but are not limited to: Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; black pepper extract (piper nigrum), including the active ingredients chavicine and pipeline; Echinacea extract; Northern Prickly Ash extract; and red pepper oleoresin. In some embodiments, alkylamides extracted from materials such as jambu or sanshool may be included. Additionally, in some embodiments, a sensation is created due to effervescence. Such effervescence is created by combining an alkaline material with an acidic material, either or both of which may be encapsulated. In some embodiments, an alkaline material may include alkali metal carbonates, alkali metal bicarbonates, alkaline earth metal carbonates, alkaline earth metal bicarbonates and mixtures thereof. In some embodiments, an acidic material may include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. Examples of “tingling” type sensates can be found in U.S. Pat. No. 6,780,443, the entire contents of which are incorporated herein by reference for all purposes. Tingling agents are described in U.S. Pat. No. 6,780,443 to Nakatsu et al., U.S. Pat. No. 5,407,665 to McLaughlin et al., U.S. Pat. No. 6,159,509 to Johnson et al. and U.S. Pat. No. 5,545,424 to Nakatsu et al., each of which is incorporated by reference herein in its entirety.

Oral care agents that may be used include those actives known to the skilled artisan, such as, but not limited to, surfactants, breath freshening agents, anti-microbial agents, antibacterial agents, anti-calculus agents, anti-plaque agents, oral malodour control agents, fluoride compounds, quaternary ammonium compounds, remineralisation agents and combinations thereof.

Suitable surfactants include, but are not limited to, salts of fatty acids selected from the group consisting of C₈-C₂₄, palmitoleic acid, oleic acid, eleosteric acid, butyric acid, caproic acid, caprylic acid, capric acid, lauric acid, myristic acid, palmitic acid, stearic acid, ricinoleic acid, arachidic acid, behenic acid, lignoceric acid, cerotic acid, sulfated butyl oleate, medium and long chain fatty acid esters, sodium oleate, salts of fumaric acid, potassium glomate, organic acid esters of mono- and diglycerides, stearyl monoglyceridyl citrate, succistearin, dioctyl sodium sulfosuccinate, glycerol tristearate, lecithin, hydroxylated lecithin, sodium lauryl sulfate, acetylated monoglycerides, succinylated monoglycerides, monoglyceride citrate, ethoxylated mono- and diglycerides, sorbitan monostearate, calcium stearyl-2-lactylate, sodium stearyl lactylate, lactylated fatty acid esters of glycerol and propylene glycerol, glycerol-lactoesters of C₈-C₂₄ fatty acids, polyglycerol esters of C₈-C₂₄ fatty acids, propylene glycol alginate, sucrose C₈-C₂₄ fatty acid esters, diacetyl tartaric and citric acid esters of mono- and diglycerides, triacetin, sarcosinate surfactants, isethionate surfactants, tautate surfactants, pluronics, polyethylene oxide condensates of alkyl phenols, products derived from the condensation of ethylene oxide with the reaction product of propylene oxide and ethylene diamine, ethylene oxide condensates of aliphatic alcohols, long chain tertiary amine oxides, long chain tertiary phosphine oxides, long chain dialkyl sulfoxides, and combinations thereof.

Suitable antibacterial agents include, but are not limited to, chlorhexidine, alexidine, quaternary ammonium salts, benzethonium chloride, cetyl pyridinium chloride, 2,4,4′-trichloro-2′-hydroxy-diphenyl ether (triclosan) and combinations thereof.

Suitable fluoride compounds include, but are not limited to, sodium fluoride, sodium monoflorophosphate, stannous fluoride and combinations thereof.

Suitable anti-calculus agents include, but are not limited to, pyrophosphates, triphosphates, polyphosphates, polyphosphonates, dialkali metal pyrophosphate salt, tetra alkali polyphosphate salt, tetrasodium pyrophosphate, tetrapotassium pyrophosphate, sodium tripolyphosphate and combinations thereof.

Suitable anti-microbial agents include, but are not limited to, cetylpyridinium chloride, zinc compounds, copper compounds and combinations thereof.

Suitable remineralisation agents include, but are not limited to casein phosphopeptide-amorphous calcium phosphate, casein phosphoprotein-calcium phosphate complex, casein phosphopeptide-stabilized calcium phosphate, and combinations thereof.

Other oral care actives known to those skilled in the art are considered well within the scope of the present invention.

Pharmaceutical actives include drugs or medicaments, breath fresheners, vitamins and other dietary supplements, minerals, caffeine, nicotine, fruit juices, and the like, and mixtures thereof. Examples of useful drugs include ace-inhibitors, antianginal drugs, anti-arrhythmias, anti-asthmatics, anti-cholesterolemics, analgesics, anesthetics, anti-convulsants, anti-depressants, anti-diabetic agents, anti-diarrhoea preparations, antidotes, anti-histamines, anti-hypertensive drugs, anti-inflammatory agents, anti-lipid agents, anti-manics, anti-nauseants, anti-stroke agents, anti-thyroid preparations, anti-tumour drugs, anti-viral agents, acne drugs, alkaloids, amino acid preparations, anti-tussives, anti-uricemic drugs, anti-viral drugs, anabolic preparations, systemic and non-systemic anti-infective agents, anti-neoplastics, anti-parkinsonian agents, anti-rheumatic agents, appetite stimulants, biological response modifiers, blood modifiers, bone metabolism regulators, cardiovascular agents, central nervous system stimulates, cholinesterase inhibitors, contraceptives, decongestants, dietary supplements, dopamine receptor agonists, endometriosis management agents, enzymes, erectile dysfunction therapies such as sildenafil citrate, which is currently marketed as Viagra®, fertility agents, gastrointestinal agents, homeopathic remedies, hormones, hypercalcemia and hypocalcemia management agents, immunomodulators, immunosuppressives, migraine preparations, motion sickness treatments, muscle relaxants, obesity management agents, osteoporosis preparations, oxytocics, parasympatholytics, parasympathomimetics, prostaglandins, psychotherapeutic agents, respiratory agents, sedatives, smoking cessation aids such as bromocryptine or nicotine, sympatholytics, tremor preparations, urinary tract agents, vasodilators, laxatives, antacids, ion exchange resins, anti-pyretics, appetite suppressants, expectorants, anti-anxiety agents, anti-ulcer agents, anti-inflammatory substances, coronary dilators, cerebral dilators, peripheral vasodilators, psycho-tropics, stimulants, anti-hypertensive drugs, vasoconstrictors, migraine treatments, antibiotics, tranquilizers, anti-psychotics, anti-tumour drugs, anti-coagulants, anti-thrombotic drugs, hypnotics, anti-emetics, anti-nauseants, anti-convulsants, neuromuscular drugs, hyper- and hypo-glycemic agents, thyroid and anti-thyroid preparations, diuretics, anti-spasmodics, terine relaxants, anti-obesity drugs, erythropoietic drugs, anti-asthmatics, cough suppressants, mucolytics, DNA and genetic modifying drugs, and combinations thereof.

In some embodiments, a mixture of at least one active substance and at least one taste potentiator is encapsulated, rather than encapsulating the taste potentiator or the active substance alone. Similar to above, the encapsulant may be selected to delay or increase the rate of release of the mixture of components. Any of the encapsulants described above may be employed.

For example, in some embodiments, the active substance(s) may be at least one intense sweetener, including the sweetener composition of the invention. The intense sweetener(s) may be mixed with at least one taste potentiator, which is selected to increase the sweet taste of the intense sweetener(s). This mixture of components may then be encapsulated. Examples of additional suitable intense sweeteners include, but are not limited to, neotame, aspartame, Acesulfame-K, sucralose, saccharin and combinations thereof.

In embodiments including an encapsulated mixture of active(s) and potentiator(s), the active substance(s) may be present in amounts of about 1% to about 95% by weight of the composition, more specifically about 5% to about 30% by weight. The taste potentiator(s) may be present in amounts of about 0.01% to about 12% by weight of the composition, more specifically about 0.1% to about 5% by weight. The encapsulant may be present in amounts of about 1% to about 95% by weight of the composition, more specifically about 10% to about 60% by weight.

As mentioned above, some embodiments may include a mixture of at least one encapsulated taste potentiator and at least one taste potentiator in its free form. The encapsulated and unencapsulated taste potentiators may be the same or different. The encapsulated taste potentiator(s) may be encapsulated by any of the materials described above. The mixture of encapsulated and unencapsulated taste potentiators may be combined with one or more active substances to provide a potentiator composition.

Some other embodiments provide compositions that modulate the activity of taste receptor cells in a mammal. Such compositions may include at least one active substance and at least one taste potentiator, as described above. These components may be encapsulated or unencapsulated, also as described above. The taste potentiator(s) may modulate the activity of taste receptor cells upon consumption of the composition. More specifically, taste is perceived through sensory cells located in the taste buds. Different signaling mechanisms sense the primary tastes of salty, sour, sweet, bitter and umami. Eventually a nerve impulse is triggered in the brain that is sensed as one of these primary tastes.

Taste potentiators function by modulating the activity of taste receptor cells at some point in this taste signaling pathway. For instance, in some cases, taste potentiators may bind to taste receptors, such as, for example, sweet taste receptors, which thereby enhances the perception of the sweet taste. In other embodiments, for example, taste potentiators may block taste receptors, such as, for example bitter receptors, which suppresses the perception of a bitter taste and thereby enhances the perception of a sweet taste. Taste potentiator(s), therefore, modulate the activity of taste receptor cells in mammals, which thereby enhances the perception of a given taste. This activity may enhance the perception of an active substance contained in the composition when consumed in conjunction with a taste potentiator.

### Beverage Compositions

In some embodiments, the potentiator compositions may reside in a beverage composition including at least one active substance including the sweetener composition of the invention and at least one taste potentiator. Beverages suitable for use herein include, for example, soft or carbonated drinks, juice-based drinks, milk-based drinks, beverages made from brewed components such as teas and coffees, beverage mixes, beverage concentrates, powdered beverages, beverage syrups, frozen beverages, gel beverages, alcoholic beverages, and the like.

The beverages may include any of the potentiator compositions described herein. In general, the potentiator compositions are present in the beverage compositions in amounts of about 0.001% to about 0.100%, more specifically about 0.02% to about 0.08%, and even more specifically about 0.04% to about 0.06% by weight of the beverage composition.

Of course, the required concentrations will depend upon the nature of the beverage to be sweetened, the level of sweetness required, the nature of any additional sweetener(s) in the product and the degree of enhancement required.

In some embodiments, some or all of the active and/or the taste potentiator may be employed in a free form (e.g., unencapsulated). Alternatively, the beverage composition may include some or all of the active and/or the taste potentiator in an encapsulated form. As a further alternative, the beverage composition may include some of the active and/or the taste potentiator in a free form and some of the active and/or the taste potentiator in an encapsulated form. In some embodiments, the beverage composition may include two or more potentiator compositions.

### Juice-Based Compositions

Juice-based compositions generally contain a juice component obtained from fruit or vegetable. The juice component can be used in any form such as a juice form, a concentrate, an extract, a powder, or the like.

Suitable juices include, for example, citrus juice, non-citrus juice, or mixtures thereof, which are known for use in beverages. Examples of such juices include, non-citrus juices such as apple juice, grape juice, pear juice, nectarine juice, currant juice, raspberry juice, gooseberry juice, blackberry juice, blueberry juice, strawberry juice, custard-apple juice, pomegranate juice, guava juice, kiwi juice, mango juice, papaya juice, watermelon juice, cantaloupe juice, cherry juice, cranberry juice, peach juice, apricot juice, plum juice, and pineapple juice; citrus juices such as orange juice, lemon juice, lime juice, grapefruit juice, and tangerine juice; and vegetable juice such as carrot juice and tomato juice; or a combination comprising at least one of the foregoing juices.

Unless otherwise indicated, juice as used can include fruit or vegetable liquids containing a percentage of solids derived from the fruit or vegetable, for example pulp, seeds, skins, fibres, and the like, and pectin, which is naturally occurring in the fruit or vegetable. The amount of solids in the juice can be about 1 to about 75 wt %, specifically about 5 to about 60 wt %, more specifically about 10 to about 45 wt %, and yet more specifically about 15 to about 30 wt % each based on the total weight of the juice. Higher concentrations of solids can be found in juice concentrates, purees, and the like.

The amount of juice component present in the juice-based composition generally can be about 0.1 wt % to about 95 wt % based on the total weight of the composition, specifically about 5 wt % to about 75 wt %, and more specifically about 10 wt % to about 50 wt % each based on the total weight of the composition. Amounts may vary depending upon whether the composition is a concentrate or a ready to drink beverage, for example. The remaining components in the juice-based composition can be added water or other suitable liquid, a sweetening agent, a flavouring agent, or other additives as described herein.

The juice-based composition can be non-carbonated or carbonated.

In one embodiment, the juice-based composition is fortified with solubilised calcium in the form of calcium carbonate, calcium oxide, or calcium hydroxide, for example. A food-grade acid is added to the calcium fortified juice-based composition to improve the solubility of calcium. Exemplary food-grade acids suitable for use in the juice-based composition are further discussed herein, specifically citric acid, malic acid, or a combination comprising at least one of the foregoing food-grade acids.

In some embodiments, the juice-based composition can be formed from a fruit or vegetable using a hot break or cold break process. In both processes, the fruit or vegetable is macerated and passed through conventional equipment to separate out seeds, skins and other undesired solids. The composition is then concentrated by conventional techniques. In hot break processes, the fruit or vegetable is typically heated during maceration or immediately thereafter to deactivate enzymes that may degrade the product and decrease the viscosity of the product. In cold break processes, the fruit or vegetable typically are processed at lower temperatures than hot break. A hot break process accordingly may provide a thicker product than those produced by a cold break process.

In one embodiment, the juice-based composition is pasteurized to destroy unwanted micro-organisms. Suitable pasteurization conditions of juice-based compositions can be selected by one of ordinary skill in the art without undue experimentation using the guidelines provided. An exemplary pasteurization process to sterilize the juice-based composition is by heating the composition to about 60 to about 80° C. for about 6 to about 15 minutes in an aseptic environment.

In another embodiment, the juice-based composition is filled into a beverage container and then subjected to pasteurization conditions. Alternatively, the composition is hot-filled into a beverage container at temperatures sufficient to sterilize the composition in the container.

In another embodiment, the juice-based composition can contain a preservative allowing the composition to be cold-filled into a beverage container without the need for pasteurization. Specifically, the preservatives can be added to lower the pH level of the beverage to pH of about 3 to about 4.5. Suitable preservatives are discussed in detail herein.

### Milk-Based Compositions

Milk-based compositions generally contain a dairy component which can contain varying amounts of milk proteins (e.g., casein, whey protein, and the like), fats, lactose, and water. Exemplary dairy components include yogurt, cream, whole milk, low or reduced fat milk, skim milk, milk solids, condensed milk, or a combination comprising at least one of the foregoing dairy components.

In some embodiments, non-dairy components may replace part or all of the dairy components in the milk-based composition. Suitable non-dairy components include soy milk, almond milk, coconut milk, rice milk, and the like, or a combination comprising at least one of the foregoing.

Stabilizers can be added to the milk-based composition to prevent precipitation. Exemplary stabilizers include hydrocolloids such as pectin, propylene glycol alginate, and the like, as well as the stabilizers described further herein.

The amount of milk proteins in a milk-based beverage composition can be about 0.1% to about 10% by weight based on the total weight of the milk-based beverage composition, specifically about 0.5% to about 5% by weight, and more specifically about 1.0% to about 4% by weight.

The milk-based composition can contain a sweetening agent, colouring agent, or other additives as disclosed herein. The milk-based composition can be non-carbonated or carbonated.

In some embodiments, the milk-based beverage is lactose free.

The process for preparing milk-based beverage compositions generally includes mixing and emulsifying a dairy component or non-dairy component with an emulsifier to form an emulsified component. The emulsified component can be pasteurized, cooled, and blended with a second component, which can contain a flavouring agent, a sweetening agent, other additives, or water or other suitable liquid to form a beverage composition. The blending can be performed under aseptic conditions to ensure product integrity.

Suitable conditions for the pasteurization of milk-base compositions can be selected by one of ordinary skill in the art without undue experimentation using the guidelines provided. An exemplary pasteurization process to sterilize the emulsified component or other dairy component can be effected at temperatures of about 130 to about 140° C. for about 30 seconds to about 2 minutes in an aseptic environment. Alternatively, the pasteurization can be performed at about 115 to about 125° C. for about 20 to about 30 minutes in an aseptic environment.

In another embodiment, the milk-based composition is filled into a beverage container and then subjected to the pasteurization conditions.

### Alcoholic Compositions

The compositions described herein may further comprise an alcoholic composition. Examples of suitable alcoholic compositions include beer, spirit, liqueur, wine, or a combination comprising at least one of the foregoing. In some embodiments, the level of alcohol, as measured by the amount of ethanol contained in the beverage composition can be about 0.5 vol % to about 20 vol % based on the total volume of the beverage composition.

### Carbonated Compositions

A carbonated beverage composition typically contains about 0.1 to about 5.0 volumes of gas or gasses, typically carbon dioxide, per volume of the beverage composition. The carbonation can be effected by forceful introduction of the gas under pressure to the beverage composition. Cooling the beverage composition allows for greater amounts of carbon dioxide to be solubilised by the beverage composition. Carbonation can be used to enhancing the flavour, sweetness, taste, and mouth-feel of the composition. Additionally, carbonation lowers the pH of the composition.

In one embodiment, the carbonation can be added to the finished, non-carbonated beverage composition, which contains all of the desired beverage components.

In another embodiment, the carbonation is added to a desired volume of water to form a carbonated water. The carbonated water can then be combined with a composition such as a beverage concentrate or beverage syrup to produce the finished carbonated beverage composition.

Once the carbonated beverage composition has been prepared, the carbonated beverage composition can be packaged in containers and sealed using methods, packaging, and equipment selected by those of ordinary skill in the art without undue experimentation.

In some embodiments, carbonation can be added at the point of consumption. For example, in a restaurant or convenience store, a fountain beverage consisting of a beverage syrup and a source of carbonation is prepared for imminent consumer consumption.

### Frozen Compositions

A “frozen beverage composition” as used herein includes a beverage composition having ice crystals suspended therein to provide a viscous, yet drinkable beverage. The consistency of the frozen beverage composition allows it to have a “slushy” or “spoonable” consistency. The ice crystals can be present in the frozen beverage composition in an amount of about 20 to about 90 wt %, specifically about 30 to about 70 wt %, and yet more specifically about 40 to about 50 wt % ice solids each based on the total weight of the frozen beverage composition.

Due to the lower temperature of the frozen beverage composition compared with other beverages, choice in the amount of flavouring agent and/or sweetening agent can be different. Suitable amounts of flavouring agent and sweetening agent can be selected by one of ordinary skill in the art without undue experimentation.

The frozen beverage composition can contain a buffering salt, which aids in lowering the freezing point of the beverage composition and to maintain the “slushy” texture. Suitable buffering salts include sodium, potassium, and calcium salts of citric acid or phosphoric acid: sodium citrate, potassium citrate, disodium phosphate, dipotassium phosphate, monocalcium phosphate, tricalcium phosphate, or a combination comprising at least one of the foregoing buffering salts.

### Gel Compositions

A “gel beverage composition” as used herein includes a beverage composition having a thickening agent to provide a viscous, yet drinkable beverage. The consistency of the gel beverage composition allows it to have a “semi-solid” or “spoonable” consistency. Thickening agents (sometimes referred to as hydrocolloids) can include, but are not limited to natural and synthetic gums, for example locust bean gum, guar gum, gellan gum, xanthan gum, gum ghatti, modified gum ghatti, tragacanth gum, carrageenan, and the like; natural and modified starches, for example pregelatinized starch (corn, wheat, tapioca), pregelatinized high amylose-content starch, pregelatinized hydrolyzed starches (maltodextrins, corn syrup solids), chemically modified starches such as pregelatinized substituted starches (e.g., octenyl succinate), and the like; cellulose derivatives, for example carboxymethylcellulose, sodium carboxymethylcellulose, and the like; polydextrose; whey or whey protein concentrate; pectin; gelatin; or a combination comprising at least one of the foregoing thickening agents.

Due to the textural difference of the gel beverage composition compared with other beverages, choice in the amount of flavouring agent and/or sweetening agent can be different. Suitable amounts of flavouring agent and sweetening agent can be selected by one of ordinary skill in the art without undue experimentation.

Any of the beverage compositions described herein may include flavours and optional sweeteners in addition to the sweetener composition of the invention and a variety of optional additives. In some embodiments, the composition may include optional additives such as antioxidants, amino acids, caffeine, colouring agents (“colourants”, “colourings”), emulsifiers, flavour potentiators, food-grade acids, minerals, micronutrients, plant extracts, phytochemicals (“phytonutrients”), preservatives, salts including buffering salts, stabilizers, thickening agents, medicaments, vitamins, or a combination comprising at least one of the foregoing additives. Those of ordinary skill in the art will appreciate that certain additives may meet the definition or function according to more than one of the above-listed additive categories.

Suitable food-grade acids for use in the composition include, for example, acetic acid, adipic acid, ascorbic acid, butyric acid, citric acid, formic acid, fumaric acid, glyconic acid, lactic acid, malic acid, phosphoric acid, oxalic acid, succinic acid, tartaric acid, or a combination comprising at least one of the foregoing food-grade acids. The food-grade acid can be added as acidulant to control the pH of the beverage and also to provide some preservative properties; or to stabilize the beverage.

The pH of the beverage may also be modified by the addition of food-grade compounds such as ammonium hydroxide, sodium carbonate, potassium carbonate, sodium bicarbonate, and the like, or a combination comprising at least one of the foregoing. Additionally, the pH of the beverage can be adjusted by the addition of carbon dioxide.

In some embodiments, the tartness of the beverage may be varied by selecting and combining acids to provide a desired tartness perception. Some factors to consider in determining a desired tartness include, but are not limited to, the acid's dissociation constant, solubility, pH, etc. These variables can be measured by measuring the titratable acidity of the beverage composition.

Colouring agents can be used in amounts effective to produce a desired colour for the composition. The colourants may include pigments, natural food colours and dyes suitable for food, drug and cosmetic applications. A full recitation of all F.D. & C. colourants and their corresponding chemical structures can be found in the Kirk-Othmer Encyclopaedia of Chemical Technology, 3rd Edition, in volume 5 at pages 857-884, of which text is incorporated herein by reference.

As classified by the United States Food, Drug, and Cosmetic Act (21 C.F.R. 73), colours can include exempt from certification colours (sometimes referred to as natural even though they can be synthetically manufactured) and certified colours (sometimes referred to as artificial), or a combination comprising at least one of the foregoing. In some embodiments, exemplary exempt from certification or natural colours can include, annatto extract, (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape colour extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), or a combination comprising at least one of the foregoing.

In some embodiments, exemplary certified colours can include FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), or a combination comprising at least one of the foregoing. In some embodiments, certified colours can include FD&C aluminium lakes. These consist of the aluminium salts of FD&C dyes extended on an insoluble substrate of alumina hydrate. Additionally, in some embodiments, certified colours can be included as calcium salts.

Acceptable colouring agents are specifically water-soluble colouring agents.

Suitable amounts of colourant to provide the desired visual effect can be selected by one of ordinary skill in the art without undue experimentation using guidelines provided. Exemplary amounts of colouring agents can be about 0.005 to about 15 wt %, specifically about 0.01 to about 6 wt %, and more specifically about 0.1 to about 2 wt % each based on the total weight of the composition.

Emulsifiers can be added to the composition to prevent separation of the composition components by keeping ingredients dispersed. Emulsifiers can include molecules which have both a hydrophilic part and a hydrophobic part. Emulsifiers can operate at the interface between hydrophilic and hydrophobic materials of the beverage to prevent separation of the components of the composition. Suitable emulsifiers for use in the compositions include, for example, lecithin (e.g., soy lecithin); mono and diglycerides of long chain fatty acids, specifically saturated fatty acids, and more specifically, stearic and palmitic acid mono- and diglycerides; mono and diglycerides of acetic acid, citric acid, tartaric acid, or lactic acid; egg yolks; polysorbates (e.g., polysorbate 20, polysorbate 40, polysorbate 60, polysorbate 65, and polysorbate 80), propylene glycol esters (e.g., propylene glycol monostearate); propylene glycol esters of fatty acids; sorbitan esters (e.g., sorbitan monostearates, sorbitan tristearates, sorbitan monolaurate, sorbitan monooleate), Acacia (gum arabic), sucrose monoesters; polyglycerol esters; polyethoxylated glycerols; and the like, or a combination comprising at least one of the foregoing emulsifiers.

The beverage composition may contain an emulsifier in an amount of about 0.001% to about 2.00%, specifically about 0.005% to about 1.00%, more specifically about 0.01% to about 0.5%, and yet more specifically about 0.05% to about 0.1% by weight of the composition.

Certain components (sometimes referred to as hydrocolloids) that act as thickening agents which can impart added “mouth-feel” to the composition include natural and synthetic gums, for example locust bean gum, guar gum, gellan gum, xanthan gum, gum ghatti, modified gum ghatti, tragacanth gum, carrageenan, and the like; natural and modified starches, for example pregelatinized starch (corn, wheat, tapioca), pregelatinized high amylose-content starch, pregelatinized hydrolyzed starches (maltodextrins, corn syrup solids), chemically modified starches such as pregelatinized substituted starches (e.g., octenyl succinate), and the like; cellulose derivatives, for example carboxymethylcellulose, sodium carboxymethylcellulose, and the like; polydextrose; whey or whey protein concentrate; pectin; gelatin; or a combination comprising at least one of the foregoing thickening agents.

The composition may contain a thickening agent in an amount of about 0.001% to about 10%, specifically about 0.005% to about 5%, more specifically about 0.01% to about 1%, and yet more specifically about 0.05% to about 0.5% by weight of the composition.

Preservatives, including antimicrobials, can be added to the composition to provide freshness and to prevent the unwanted growth of bacteria, molds, fungi, or yeast. The addition of a preservative, including antioxidants, may also be used to maintain the composition's colour, flavour, or texture. Any suitable preservatives for use in food and beverage products can be incorporated into the compositions. Examples of suitable preservatives include benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, or a combination comprising at least one of the foregoing preservatives.

The composition may contain the preservative or preservative combination in an amount of about 0.0001% to about 0.10%, specifically about 0.001% to about 0.08%, more specifically about 0.005% to about 0.05%, and yet more specifically about 0.01% to about 0.04% by weight of the composition.

The composition may be fortified or enriched with vitamins, minerals, micronutrients, or other nutrients. Micronutrients can include materials that have an impact on the nutritional well being of an organism even though the quantity required by the organism to have the desired effect is small relative to macronutrients such as protein, carbohydrate, and fat. Micronutrients can include, but are not limited to vitamins, minerals, enzymes, phytochemicals, antioxidants, and combinations thereof.

Suitable vitamins or vitamin precursors include ascorbic acid (Vitamin C), beta carotene, niacin (Vitamin B₃), riboflavin (Vitamin B₂), thiamin (Vitamin B₁), niacinamide, folate or folic acid, alpha tocopherols or esters thereof, Vitamin D, retinyl acetate, retinyl palmitate, pyridoxine (Vitamin B₆), folic acid (Vitamin B₉), cyanocobalimin (Vitamin B₁₂), pantothenic acid, biotin, or a combination comprising at least one of the foregoing vitamins.

In some embodiments, vitamins or vitamin precursors may include fat soluble vitamins such as vitamin A, vitamin D, vitamin E, and vitamin K and combinations thereof. In some embodiments, vitamins or vitamin precursors can include water soluble vitamins such as vitamin C (ascorbic acid), the B vitamins (thiamine or B₁, riboflavin or B₂, niacin or B₃, pyridoxine or B₆, folic acid or B₉, cyanocobalimin or B₁₂, pantothenic acid, biotin), and combinations thereof.

Exemplary minerals include sodium, magnesium, chromium, iodine, iron, manganese, calcium, copper, fluoride, potassium, phosphorous, molybdenum, selenium, zinc, or a combination comprising at least one of the foregoing minerals. The minerals can be provided as a mineral salt, including carbonate, oxide, hydroxide, chloride, sulfate, phosphate, pyrophosphate, gluconate, lactate, acetate, fumarate, citrate, malate, amino acids and the like for the cationic minerals and sodium, potassium, calcium, magnesium and the like for the anionic minerals.

The amount of vitamins or minerals provided in the compositions may be up to or exceeding amounts generally recognized as U.S. Recommended Daily amounts or the Recommended Daily Intake amounts established by the U.S. Food and Drug Administration.

In some embodiments micronutrients may include but are not limited to L-carnitine, choline, coenzyme Q10, alpha-lipoic acid, omega-3-fatty acids, pepsin, phytase, trypsin, lipases, proteases, cellulases, and combinations thereof.

Antioxidants may include materials that scavenge free radicals. In some embodiments, antioxidants can include but are not limited to ascorbic acid, citric acid, rosemary oil, vitamin A, vitamin E, vitamin E phosphate, tocopherols, di-alpha-tocopheryl phosphate, tocotrienols, alpha lipoic acid, dihydrolipoic acid, xanthophylls, beta cryptoxanthin, lycopene, lutein, zeaxanthin, astaxanthin, beta-carotene, carotenes, mixed carotenoids, polyphenols, flavinoids, and combinations thereof.

Exemplary nutrients also may include amino acids such as L-tryptophan, L-lysine, L-leucine, L-methionine, 2-aminoethanesulfonic acid (taurine), and L-carnitine; creatine; glucuronolactone; inositol; or a combination comprising at least one of the foregoing nutrients.

Phytochemicals (“phytonutrients”) are plant derived compounds which may provide a beneficial effect on the health or well-being of the consumer. Phytochemicals include plant derived antioxidants, phenolic compounds including monophenols and polyphenols, and the like. Exemplary phytochemicals include lutein, lycopene, carotene, anthocyanin, capsaicinoids, flavonoids, hydroxycinnamic acids, isoflavones, isothiocyanates, monoterpenes, chalcones, coumestans, dihydroflavonols, flavanoids, flavanols, quercetin, flavanones, flavones, flavan-3-ols (catechins, epicatechin, epigallocatechin, epigallocatechingallate, and the like), flavonals (anthocyanins, cyanidine, and the like); phenolic acids; phytosterols, saponins, terpenes (carotenoids), or a combination comprising at least one of the foregoing phytochemicals.

The phytochemicals may be provided in substantially pure or isolated faun or in the form of natural plant extracts. Suitable plant extracts which contain one or more phytochemicals include fruit skin extracts (grape, apple, crab apple, and the like), green tea extracts, white tea extracts, green coffee extract, or a combination comprising at least one of the foregoing extracts.

Various herbals, aromatic plants or plant parts or extracts thereof, also may be included in the compositions for a variety of reasons such as for flavour or for their potential health benefits. Exemplary herbals include Echinacea, Goldenseal, Calendula, Rosemary, Thyme, Kava Kava, Aloe, Blood Root, Grapefruit Seed Extract, Black Cohosh, Ginseng, Guarana, Cranberry, Ginko Biloba, St. John's Wort, Evening Primrose Oil, Yohimbe Bark, Green Tea, Ma Huang, Maca, Bilberry, extracts thereof, or a combination comprising at least one of the foregoing herbals.

### Concentrate Compositions

Concentrate compositions may be in dry form (e.g., powder or tablet) or in liquid form (e.g., syrup, suspension, or emulsion). Concentrate compositions typically include the flavouring agent in a volume of liquid medium that is less than the volume of liquid medium found in the finished beverage. Other optional components in the concentrate include additional sweetening agents, colouring agents, and other additives such as food-grade acids, preservatives, and the like. The bulk of the liquid component of a finished beverage composition is not present in the concentrate to allow for reduced weight, volume, storage and shipping costs while at the same time allowing for increased shelf life of the concentrate versus beverage composition.

In one embodiment, the concentrate composition is formulated to provide final beverage compositions upon dilution with about a 2-fold to about a 5-fold by volume, specifically about 3-fold to about a 4-fold by volume of a liquid. The liquid may be water, juice, dairy component, a non-dairy milk, ethanol, a combination comprising at least one of the foregoing, and the like. The liquid may be in noncarbonated or carbonated form.

### Processing and Packaging of Beverage Products

In some embodiments, the beverage composition is subject to homogenization conditions, such as high pressure homogenization, to provide a homogenous composition. The beverage component used to prepare a beverage composition or concentrate composition can be homogenized alone, or alternatively, juice and other components can be homogenized together to form a homogenized beverage composition or homogenized concentrate composition.

High pressure homogenization may be used and in some embodiments, juice solids are mashed under pressure. In general, homogenization processes alter the size and distribution of the fruit or vegetable pulp particles. More specifically, homogenization may break down and uniformly distribute the lipophilic components, the fruit or vegetable pulp particles, etc. throughout the composition. In addition, homogenization may modify the fruit or vegetable fibres found in the composition by reducing the length and fraying the ends of the fibrous materials. This may allow the fibre strands to absorb more liquid. Overall, homogenization may produce a more uniform composition having increased viscosity. Homogenization accordingly may impart a smoother mouthfeel to the composition.

In some embodiments, homogenization pressures of about 1000 pounds per square inch (psi) to about 4000 psi is used. Any conventional homogenization equipment can be employed, such as equipment available from APV Gaulin, Alfa-Laval or Niro Soavi.

In some embodiments, the beverage composition is pasteurized to sterilize the product by destroying unwanted micro-organisms. Exemplary processes to destroy or remove unwanted micro-organisms include hot-filling, aseptic packaging, ozonation, radiation (e.g., ultraviolet light or gamma rays), membrane permeation, pulsed electric field, sonication, and the like.

Depending upon the components of the beverage composition, pasteurization may be effected at different temperatures. For dairy, grain, fruit or vegetable-based beverage compositions a pasteurization temperature of about 60° C. to about 80° C. can be sufficient, specifically about 65° C. to about 75° C., and more specifically about 68° C. to about 72° C. More specifically, the fruit or vegetable-based beverage composition can be pasteurized by heating to the desired temperature for about 6 about 15 minutes in an aseptic environment, more specifically about 8 about 12 minutes, and yet more specifically about 9 about 11 minutes.

For milk-based beverage compositions, a pasteurization temperature of about 60° C. to about 80° C. may be used, specifically about 65° C. to about 75° C., and more specifically about 68° C. to about 72° C. More specifically, the milk-based beverage composition may be pasteurized by heating to the desired temperature for about 6 about 15 minutes in an aseptic environment, more specifically about 8 about 12 minutes, and yet more specifically about 9 about 11 minutes.

The beverage composition may be bulk pasteurized and then filled into a desired beverage container. In some embodiments, the beverage composition is filled into the desired beverage container, such as a glass bottle, and then subjected to the pasteurization conditions.

Alternatively, in some embodiments, the beverage composition is hot-filled into the desired beverage container. More specifically, the beverage composition is filled into the beverage container at temperatures sufficient to sterilize the composition in the container, for example about 85° C. After several minutes, the container and composition can be cooled down to about 32° C. to about 38° C.

In other embodiments, the beverage composition is cold-filled into a desired beverage container. In such embodiments, preservatives can be added to the beverage composition. More specifically, cold-filling the beverage involves adding the beverage to the beverage container at ambient temperature (e.g., about 21° C.). Preservatives, such as those described herein, can be added to the composition to lower the pH level of the composition. Desirable pH values can be about 3 to about 4.5. Cold-filling with preservatives is used in some embodiments as an alternative to pasteurization.

In some embodiments, aseptic processes can be used to provide shelf stable, sterile beverages.

The beverage compositions may be packaged, ready-to-drink, and can be shelf stable. Any type of beverage packaging may be used to package the beverage composition including glass bottles, plastic bottles and containers (e.g., polyethylene terephthalate or foil lined ethylene vinyl alcohol), metal cans (e.g., coated aluminium or steel), lined cardboard containers, and the like. Other beverage packaging material known to one of ordinary skill in the art may be used.

The present invention also provides methods of maintaining a desired sweetness intensity in a beverage composition. In accordance with such methods, a desired sweetness intensity first may be determined. Once the desired sweetness intensity is determined, a quantity of natural or artificial sweetener may be added to a beverage composition that supplies a sweetness intensity less intense than the desired sweetness intensity. Subsequently, a quantity of a sweetener potentiator composition including 3-HB and 3,4-DHB may be added to the beverage composition such that the desired sweetness intensity is delivered.

In accordance with some other embodiments, methods of increasing the sweetness intensity of a beverage composition are provided. A quantity of natural or artificial sweetener first may be added to a beverage composition. Subsequently, a sweetness intensity derived from the quantity of the natural or artificial sweetener may be determined. Then a quantity of a sweetener potentiator composition including 3-HB and 3,4-DHB may be added to the beverage composition such that the sweetness intensity is greater than the sweetness intensity derived from the natural or artificial sweetener.

In some other embodiments, methods of reducing the amount of natural or artificial sweeteners in a beverage composition are provided. In accordance therewith, an amount of natural or artificial sweetener in a beverage composition that provides a desired sweetness intensity first may be determined. That amount may be reduced and a quantity of a sweetener potentiator composition may be added to the beverage composition such that the desired sweetness intensity is maintained.

Unless otherwise stated each of the integers described in the invention may be used in combination with any other integer as would be understood by the person skilled in the art. Further, unless otherwise stated all percentages appearing in the specification are percentages by weight of the composition being described. Accordingly, where reference is made to the formulation for preparing a bonding composition, all percentages are by weight of the formulation. However, where reference is made to the composition per se, all percentages are percentages by weight of the bonding composition. In addition, although all aspects of the invention preferably “comprise” the features described in relation to that aspect, it is specifically envisaged that they may “consist” or “consist essentially” of those features outlined in the claims.

In order that the present invention may be more readily understood, it will be described further with reference to the specific examples hereinafter.

### EXAMPLES

The invention will now be described, by way of example only, by reference to the accompanying figures, of which:

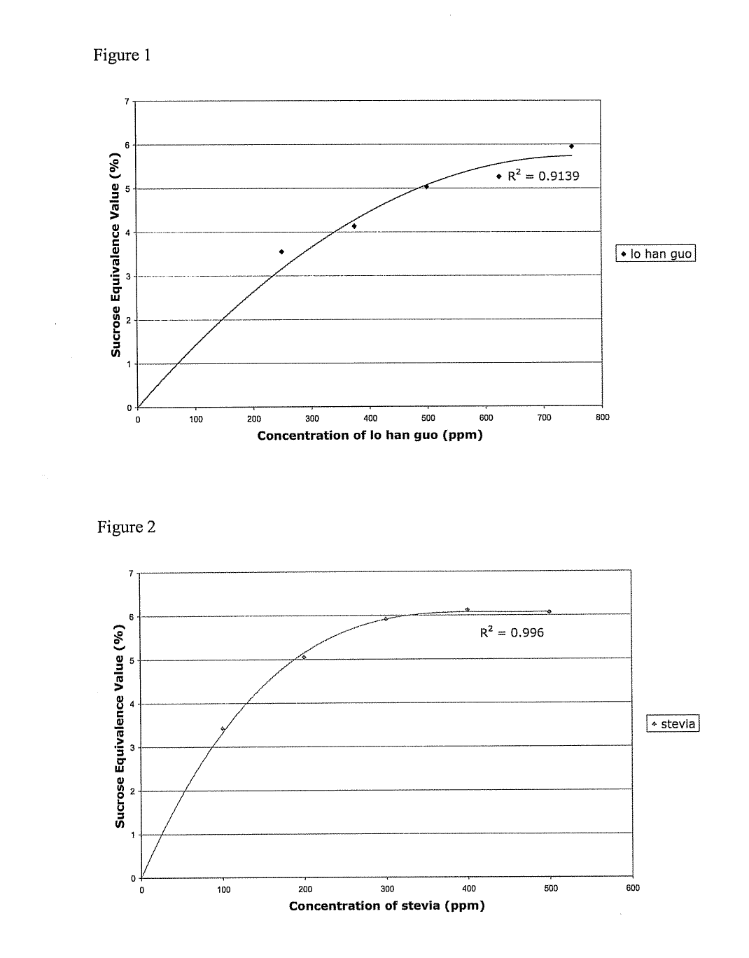

FIG. 1 is a dose response curve for LHG (PureLo 2006); and

FIG. 2 is a dose response curve for Stevia (SoooLite Pure).

A series of evaluations were carried out to investigate whether any synergy occurs between Stevia and LHG. All evaluations in this study were carried out in a model soft drink system (formulation shown in Table 1) using a small panel experienced in the assessment of sweeteners. Every assessor was presented with two randomly coded test samples at a time and each evaluation was repeated twice.

TABLE 1
Soft Drink Formulation

| Component | Supplier | 5 w/v |
|---|---|---|
| Citric acid monohydrate | Jungbunzlauer | 0.2 |
| Trisodium citrate | Tate & Lyle | 0.04 |
| Water | — | To volume |

The soft drinks were pH buffered to pH 3.2 and sweetened with blends of Stevia and LHG as outlined below.

Three sources of LHG were included in this study. PureLo supplied by Biovittoria (2006 and 2007 crop—batch numbers G20060803 and G2007002), and LHG supplied by Damin. The Stevia was SoooLite Pure sourced from Sweet Aloha Fauns (batch number 200505).

The sucrose equivalence value (SEV) of LHG (PureLo 2006) and Stevia at a range of concentrations was evaluated in order to produce dose response curves. Sweetness matching was carried out by a small panel of tasters (n=8) experienced in the assessment of sweeteners. A Stevia or LHG solution coded with a random three digit code was presented along with a series of sucrose standards increasing in concentration from 2% sucrose to 10% sucrose. Panellists were instructed to take three sips of Stevia or LHG solution, followed by three sips of sucrose standard rinsing with water in between tasting. They were asked to identify which sucrose solution most closely matched the sweetness of the Stevia or LHG solution. If the panellist judged that the sweetness fell between that of two standards they were encouraged to state this. Each concentration of Stevia or LHG was tasted in duplicate and dose response curves for both LHG and Stevia produced (the curves for PureLo 2006 and SoooLite Pure are shown by way of example in FIGS. 1 and 2). This process was repeated for the two alternative sources of LHG.

The dose response curves were then used in the evaluation of a range of Stevia and LHG blends using the previously identified equisweet levels of either LHG or Stevia, which matched the sweetness of a 5% w/v sucrose reference solution as 100% values. The results of these investigations are illustrated below:

TABLE 2
Evaluation of blends of LHG (PureLo 2006) and Stevia.

| | Stevia | LHG | |
|---|---|---|---|
| | concen- | concen- | |
| Stevia:LHG | tration | tration | |
| ratio* | (ppm) | (ppm) | Comments |
| 100:0 | 202 | — | Lingering sweetness |
| | | | Astringent |
| | | | Bitter aftertaste |
| 0:100 | — | 400 | Lingering sweetness |
| | | | Fruity/slightly smoky |
| | | | Liquorice |
| | | | Bitter aftertaste |
| 80:20 | 162 | 100 | Less lingering than either Stevia |
| | | | or LHG on their own |
| | | | Good sweetness profile |
| | | | Fruity |
| 60:40 | 121 | 200 | Can taste LHG distinctively |
| | | | More drying than 80:20 |
| | | | More sweetness build-up than |
| | | | 80:20 |
| | | | Better than LHG on its own |
| 50:50 | 101 | 250 | Stronger LHG taste |
| | | | More drying (than 60:40) |
| | | | Lingering |
| | | | Better than LHG on its own |
| 40:60 | 81 | 300 | Sweetness more delayed than |
| | | | 50:50 |
| | | | Throat-burning |
| | | | Very lingering |
| 20:80 | 40 | 400 | Sweetness more delayed (than |
| | | | 40:60) |
| | | | Very lingering |
| | | | Slightly faster sweetness onset |
| | | | than LHG on its own |

*The Stevia:LHG ratios were based on sweetness contribution and matched a 5% w/v sucrose solution in terms of sweetness intensity.

TABLE 3
Evaluation of blends of LHG (PureLo 2007) and Stevia

| | Stevia | LHG | |
|---|---|---|---|
| | concen- | concen- | |
| Stevia:LHG | tration | tration | |
| ratio* | (ppm) | (ppm) | Comments |
| 100:0 | 200 | — | Lingering sweetness |
| | | | Astringent |
| | | | Bitter aftertaste |
| 0:100 | — | 340 | Slower sweetness onset |
| | | | Sweetness builds up |
| | | | Lingering sweetness |
| 80:20 | 160 | 68 | Best sweetness profile, more |
| | | | rounded compared with both |
| | | | Stevia and LHG on their own |
| | | | Less lingering and less drying |
| | | | than Stevia/LHG on their own |
| 60:40 | 120 | 136 | Good profile, but not as good as |
| | | | 80:20 |
| 50:50 | 100 | 170 | More drying and lingering |
| 40:60 | 80 | 204 | Even more drying and lingering |
| | | | than 50:50 |

*The Stevia:LHG ratios were based on sweetness contribution and matched a 5% w/v sucrose solution in terms of sweetness intensity.

TABLE 4
Evaluation of blends of LHG (Damin) and Stevia

| | Stevia | LHG | |
|---|---|---|---|
| | concen- | concen- | |
| Stevia:LHG | tration | tration | |
| ratio* | (ppm) | (ppm) | Comments |
| 100:0 | 200 | — | Throat-catching |
| | | | Sweetness builds quickly |
| 0:100 | — | 490 | Yellowish in colour |
| | | | Mouth watering |
| | | | Fruity flavour |
| | | | Acidic and sharp |
| 80:20 | 160 | 98 | Very good |
| | | | Fast sweetness onset |
| 60:40 | 120 | 196 | Astringency increases with |
| 50:50 | 100 | 245 | increasing LHG concentration |
| 40:60 | 80 | 294 | Sweetness does not build as |
| | | | much as in LHG and Stevia on |
| | | | their own |

*The Stevia:LHG ratios were based on sweetness contribution and matched a 5% w/v sucrose solution in terms of sweetness intensity.

As can be seen from the data above, blends of Stevia and LHG have been shown to exhibit a synergic effect when used in combination. Specifically, the combination of Stevia and LHG (as shown from three separate sources of LHG) has been shown to have a more rounded sweetness profile when compared to either sweetener alone. In addition, the combination of Stevia and LHG was found to be less lingering and less drying than either sweetener when used in the absence of the other.

The optimum blend of Stevia to LHG was found to be in the region of 80:20 Stevia:LHG, however, the sweetness profile was improved where the level of Stevia was greater than LHG providing LHG was present, (i.e. from a ratio of 50:50 to about 95:05).

A number of additional model product formulations were prepared including the inventive sweetener compositions, these are described in Tables 5 to 7 below. Each was found to exhibit the favourable sweetness profile of the sweetener composition of the invention.

A boiled candy formulation comprising a 70:30 blend of Stevia:LHG was prepared by blending the components outlined in Table 5 below in a pan. A 300 g scale was used. 108.16 g of water was removed by heating to provide a hard boiled candy product of final composition 2 wt % water and final mass 300 g.

TABLE 5
Candy Formulation (70:30 Stevia:LHG)

| | | grams per 100 g of |
|---|---|---|
| Component | Supplier | initial mixture |
| Isomalt PF | Palatinit | 103.0 |
| Stevia | Sweet Aloha Farms | 0.04 |
| | (SoooLite Pure) | |
| LHG | Bio Vittoria (PureLo) | 0.02 |
| Water | — | 33.0 |

A chocolate formulation comprising a 90:10 blend of Stevia:LHG was prepared using conventional techniques. Specifically, the components outlined in Table 6 below were combined with gentle heating and subsequently allowed to solidify.

TABLE 6
Chocolate Formulation (90:10 Stevia:LHG)

| | | Wt % of |
|---|---|---|
| Component | Supplier | composition |
| Maltitol | — | 42.45 |
| Skimmed milk powder | — | 23.0 |
| Cocoa butter | — | 14.5 |
| Butterfat | — | 7.2 |
| Cocoa mass | — | 12.5 |
| Emulsifier | — | 0.3 |
| Stevia | Sweet Aloha Farms | 0.045 |
| | (SoooLite Pure) | |
| LHG | Bio Vittoria (PureLo) | 0.005 |

A chewing gum formulation comprising an 80:20 blend of Stevia:LHG was prepared using conventional techniques on a 600 g scale. Specifically, the components outlined in Table 7 below were combined with gentle heating and subsequently allowed to solidify.

TABLE 7
Chewing Gum Formulation (80:20 Stevia:LHG)

| | | Wt % of |
|---|---|---|
| Component | Supplier | composition |
| Sorbitol powder: P60 | Roquette | 50.04 |
| Sugar free gum base | — | 27.0 |
| Malitol Syrup: Lycasin | Roquette | 17.0 |
| 80/55 | | |
| Mannitol 60 | Roquette | 3.0 |
| Glycerol | Univar | 2.0 |
| Spearmint Flavour: 10555- | Givaudan | 0.8 |
| 34 | | |
| Stevia | Sweet Aloha Farms | 0.13 |
| | (SoooLite Pure) | |
| LHG | Bio Vittoria (PureLo) | 0.03 |

It is to be understood that the invention is not to be limited to the details of the above embodiments, which are described by way of example only. Many variations are possible.

1. A sweetener composition comprising:
a. an extract from the leaves of the Stevia Rebaudiana plant and/or an extract from the leaves of the Rubus suavissimus plant; and
b. an extract from the fruit of the Cucurbitaceae family;
wherein the ratio of a:b is in the range 50:50 to 95:05.

2. A sweetener composition according to claim 1 wherein the extract from the leaves of the Stevia Rebaudiana plant and/or the extract from the leaves of the Rubus suavissimus plant is selected from a stevioside or rabaudioside A.

3. A sweetener composition according to claim 1 wherein the extract from the fruit of the Cucurbitaceae family comprises Lo Han Guo.

4. A sweetener composition according to claim 1 wherein the ratio of a:b is in the range 70:30 to 90:10.

5. A sweetener composition according to claim 4 wherein the ratio of a:b is in the range 75:25 to 80:20.

6. A sweetener composition according to claim 1 additionally comprising at least one saccharide.

7. A method of making a sweetener composition comprising combining an extract from the leaves of the Stevia Rebaudiana plant and/or an extract from the leaves of the Rubus suavissimus plant, with an extract from the fruit of the Cucurbitaceae family; in a ratio in the range 50:50 to 95:05.

8. A method of improving the taste of a beverage or foodstuff comprising incorporating the sweetener composition of claim 1 into the beverage or foodstuff.

9. A method according to claim 8 wherein the beverage or foodstuff is a beverage.

10. A method according to claim 8 wherein the beverage or foodstuff is selected from chocolate, candy, chewing gum or a combination thereof.

11. A method according to claim 8 wherein the sweetener composition is present in the beverage or foodstuff in the range 0.001 to 10.0 wt % of the beverage or foodstuff.

12. A beverage or foodstuff comprising the sweetener composition of 1.

13. The beverage or foodstuff of claim 12 wherein the sweetener composition fully replaces sugar or artificial sweeteners.

14. The beverage or foodstuff of claim 12 wherein the sweetener composition partially replaces sugar or artificial sweeteners.
